(19) United States
(12) Patent Application Publication
(10) Pub. No.: US 2003/0154263 A1
(43) Pub. Date: Aug. 14, 2003

(54) Server program

(75) Inventor: Fusami Hirai, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/355,133

(22) Filed: Jan. 31, 2003

(30) Foreign Application Priority Data
Feb. 12, 2002 (JP) 2002-033629

(51) Int. Cl. G06F 15/16

(52) U.S. Cl. 709/219

(57) ABSTRACT

A server program which facilitates reuse of a portion of existing software for providing a plurality of documents linked with each other through a network. When information indicating that an input by manipulation of a button being arranged in a start-of-transition screen and designating a screen transition occurs is received, an end-of-transition screen is determined based on a screen-transition table in which a correspondence between the button in the start-of-transition screen and the end-of-transition screen is predefined. At least one name of at least one item which is set in both of the start-of-transition screen and the end-of-transition screen and is to be transcribed is acquired based on screen-item definition information in which names of items set in each screen are predefined, and data which is set as the at least one item in the start-of-transition screen is transcribed into the end-of-transition screen.

### BACKGROUND OF THE INVENTION

1) Field of the Invention

The present invention relates to a server program for providing through a network a plurality of documents linked with each other. In particular, the present invention relates to a server program for performing processing for transcribing data when a document to be displayed is transitioned.

2) Description of the Related Art

Currently, service provision through a network such as the Internet is very popular. In some services provided through networks, a server performs processing in response to a request from a terminal (e.g., a personal computer), and a result of the processing is transmitted to the terminal.

When a user receives a service through the Internet, the user accesses a web site which provides the service, by using a terminal connected to the Internet. Then, the user inputs a request for processing into the terminal in accordance with a menu of the web site. In response to the processing request, the server performs the processing, and a result of the processing is displayed on a screen of the terminal.

The web search services are examples of the above services provided through networks. In the web search services, a web page which matches a keyword specified by a user is searched for, and the location of the web page is returned.

In order to search for a web site, the user accesses a portal site by using a terminal. The user inputs a search keyword into the terminal, and presses a search button. Then, a web server in which a web site is constructed (or another server which operates in cooperation with the web server) performs search processing. Next, the web site generates an HTML (Hyper Text Markup Language) document by incorporating a result of the search into a template file which is prepared in advance, and transmits the HTML document to the terminal of the user. Thus, the result of the search is displayed on the screen of the terminal, so that the user can recognize the location of the web site which matches the search keyword inputted by the user.

Currently, many transactions are performed between companies through the Internet. In those cases, a web site for receiving orders of commodities are arranged in a web server of each company, and the web server performs processing in response to inputs of orders by customers. For example, the web server performs calculations of sales amounts corresponding to order amounts and dates of deliveries.

The processing performed by the web servers in the transactions between companies slightly varies with commodities, companies, and customers. For example, when a delivery date greatly varies with whether or not a commodity is in store as in the case of book sales, it is necessary to display an inventory situation on a received-order screen. On the other hand, in the case of on-demand sales of an custom-made commodity, the item of the inventory situation is useless. That is, the requirements imposed on the web sites are slightly different even when the web sites are constructed for the same purpose of the on-demand sales.

Therefore, software for the web servers which perform processing for receiving online orders is produced on an individual basis according to requirements of each seller. At this time, many portions of the software are common to more than one seller.

However, the conventional software is not produced in a manner suitable for partial reuse. That is, it is difficult to extract and utilize only common portions of the conventional software. Therefore, in the case where a difference from existing software is related to data processing, rewriting of a source code and recompiling are necessary even when the difference from the existing software is small. It is difficult for a user who does not have knowledge of programming (e.g., a sales person) to edit a source code even when the editing is slight, and therefore the editing should be performed by a programmer skilled in programming. Thus, bothersome work is imposed on users. For example, the users are required to request programmers to do a job, and explain specifications to programmers.

### SUMMARY OF THE INVENTION

The present invention is made in view of the above problems, and the object of the present invention is to provide a server program which enables easy reuse of a portion of existing software which is designed for providing through a network a plurality of documents linked with each other.

In order to accomplish the above object, a server program which provides document data to a terminal is provided. The server program makes a computer perform a sequence of processing which comprises the steps of: (a) determining an end-of-transition screen based on a screen-transition table in which a correspondence between the end-of-transition screen and a button being arranged in a start-of-transition screen and designating a screen transition is predefined, when the computer receives information indicating that an input by manipulation of the button in the start-of-transition screen occurs; and (b) acquiring at least one name of at least one item which is set in both of the start-of-transition screen and the end-of-transition screen and is to be transcribed, based on first screen-item definition information in which names of items set in each of the start-of-transition screen and the end-of-transition screen are predefined, and transcribing data which is set as the at least one item in the start-of-transition screen, into the end-of-transition screen.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in an embodiment;

FIG. 2 is a diagram illustrating an exemplary construction of a system as an embodiment of the present invention;

FIG. 3 is a diagram illustrating a hardware construction of a web server used in the embodiment of the present invention;

FIG. 4 is a block diagram illustrating functions of the web server;

FIG. 5 is a first diagram illustrating an example of a data structure of a screen-item definition template;

FIG. 6 is a second diagram illustrating an example of a data structure of a screen-item-definition template;

FIG. 7 is a diagram illustrating an example of a data structure of a screen-transition-table template;

FIG. 8 is a diagram illustrating an example of an HTML template;

FIG. 9 is a diagram illustrating an example of a data structure of a data bean;

FIG. 10 is a conceptual diagram illustrating a flow of information at the time of screen transition;

FIG. 11 is a diagram illustrating an example of a received-order entry screen in an initial state;

FIG. 12 is a diagram illustrating an example of a description-of-received-order entry screen;

FIG. 13 is a diagram illustrating an example of a received-order entry screen after addition to descriptions of a received order;

FIG. 14 is a diagram illustrating an example of an HTML document;

FIG. 15 is a flowchart of a sequence of processing for screen transition;

FIG. 16 is a flowchart of a sequence of processing for transcribing reception-item data;

FIG. 17 is a flowchart of a sequence of processing for transcription from a start to an end of a transition;

FIG. 18 is a flowchart of a sequence of display processing;

FIG. 19 is a flowchart of a sequence of processing for providing a record of the screen-item-definition template;

FIG. 20 is a flowchart of a sequence of processing for providing a record of the screen-transition-table template;

FIG. 21 is a flowchart of a sequence of processing for updating the screen-item-definition template;

FIG. 22 is a flowchart of a sequence of processing for updating the screen-transition-table template;

FIG. 23 is a diagram illustrating an example of an HTML template the contents of which are changed;

FIG. 24 is a diagram illustrating an example of the screen-item-definition template the contents of which are changed;

FIG. 25 is a diagram illustrating an example of the received-order entry screen after the contents of the received-order entry screen are changed; and

FIG. 26 is a diagram illustrating an example of an HTML document after the contents of the HTML document are changed.

### DESCRIPTION OF THE PREFERRED EMBODIMENTS

An embodiment of the present invention is explained below with reference to drawings.

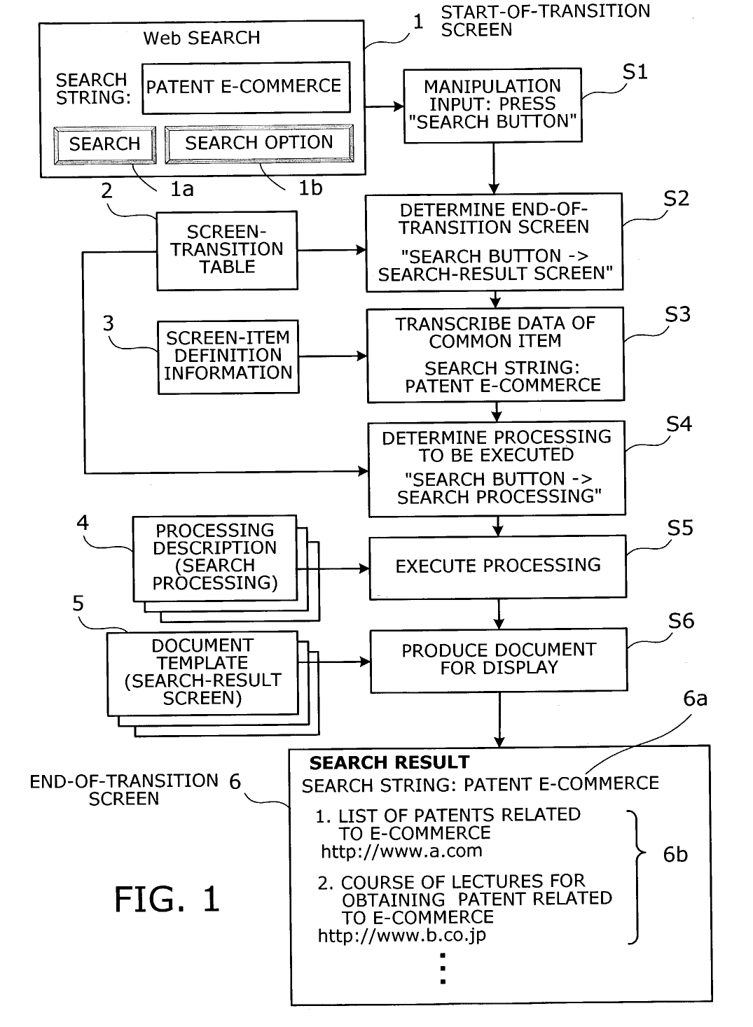

FIG. 1 is a conceptual diagram illustrating the present invention which is realized in the embodiment. In FIG. 1, as an example, the computer to which the present invention is applied is assumed to be a web server computer (hereinafter referred to as a web server), and document data in a web page is assumed to be supplied to a terminal.

Further, it is assumed that a start-of-transition screen 1 is initially displayed on the terminal. In the example of FIG. 1, a screen for making a web search is displayed. The start-of-transition screen 1 has buttons 1a and 1b which designate a screen transition. In the example of FIG. 1, the button 1a is a search button, and the button 1b is a search option button.

When a user of the terminal presses the button 1a (in step S1), information indicating that an input by manipulation of the button la in the start-of-transition screen 1 is provided for designating a screen transition is sent from the terminal to the web server. When the web server receives the above information, the web server determines an end-of-transition screen 6 based on a screen-transition table 2 in which a correspondence between the button 1a and the end-of-transition screen 6 is predefined (in step S2). Since, in the example of FIG. 1, the search button is pressed, it is determined that a search-result screen is the end-of-transition screen 6.

Next, the web server acquires at least one name of at least one item which is set in both of the start-of-transition screen 1 and the end-of-transition screen 6 and is to be transcribed, based on screen-item definition information 3, and transcribes data set under the at least one acquired name in the start-of-transition screen 1, into the end-of-transition screen (in step S3), where names of data items set in each screen is defined in the screen-item definition information 3. In the example of FIG. 1, “search string” is acquired as a name of an item to be transcribed, and “patent e-commerce,” which is set as the item “search string” in the start-of-transition screen 1, is transcribed into the end-of-transition screen 6.

In the screen-transition table 2, a correspondence between the button 1a in the start-of-transition screen 1 and a description (processing description) 4 of processing which is to be performed at the time of the screen transition is predefined. Therefore, when the web server receives the information indicating that the input by manipulation of the button 1a in the start-of-transition screen 1 for designating the screen transition is provided, the web server determines the processing description 4 corresponding to the button 1a based on the screen-transition table 2 (in step S4), and performs processing in accordance with the processing description 4 (in step S5). In the example of FIG. 1, a processing description 4 for search processing is associated with the button 1a in the screen-transition table 2. Therefore, the web server performs the search processing. The processing description in FIG. 1 is a program which is described in a predetermined programming language.

At the time of transcription of data into the end-of-transition screen 6, the web server inserts data which is set in the start-of-transition screen 1 as an item and is to be transcribed, into a document template 5 which is prepared in advance corresponding to the end-of-transition screen. Thus, the web server produces a document to be displayed (in step S6). At this time, the web server converts the data to be transcribed, into display data which has a predefined form for display.

When the produced document is sent to the terminal, the end-of-transition screen 6 is displayed on the terminal. In the end-of-transition screen 6, transcribed data 6a, a result 6b of the processing performed in accordance with the processing description 4, and the like are displayed.

According to the above server program, it is easy to start up a new web site by reusing another web site which is already constructed. For example, in order to add a new web page to an existing web site, an administrator of the web site produces a document template for the web page to be added, and adds to the screen-transition table 2 information on at least one correspondence between at least one button in a start-of-transition screen and the newly added screen. In addition, the administrator of the web site sets in the screen-item definition information 3 at least one name of at least one item to be displayed on the web page to be added. At this time, at least one name of at least one item which is to be transcribed from the start-of-transition screen is adjusted to at least one corresponding name in the start-of-transition screen. Thus, it is possible to transcribe data in the screen-item definition information, into a newly added page. In this case, the administrator is not required to have knowledge of programming.

In addition, even in the case where processing such as a web search is necessary at the time of screen transition, only registration of a description of the necessary processing in the screen-transition table 2. suffices to realize the processing. At this time, it is unnecessary to change existing processing descriptions. Therefore, even when the administrator does not have knowledge of a programming language used in production of the processing descriptions, it is possible to use in the newly produced page results of processing performed in accordance with the processing descriptions.

Further, according to the present invention, various services can be provided by using a web server. For example, it is possible to easily start up a web server for realizing transactions between companies through the Internet as an example of electronic commerce (e-commerce). Hereinbelow, an embodiment of the present invention is explained in detail by an example in which a server program according to the present invention is installed in a web server provided for realizing transactions between companies.

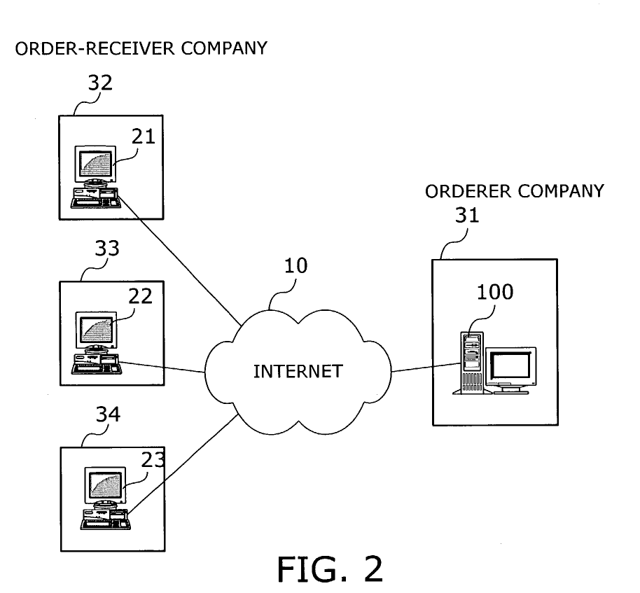

FIG. 2 is a diagram illustrating an exemplary construction of a system as the embodiment of the present invention. In this embodiment, a plurality of terminals 21 to 23 and a web server 100 are connected through the Internet 10. The web server 100 is a server computer used by an orderer company 31 in e-commerce, and the terminals 21 to 23 are computers (e.g., personal computers) in order-receiver companies 32 to 34.

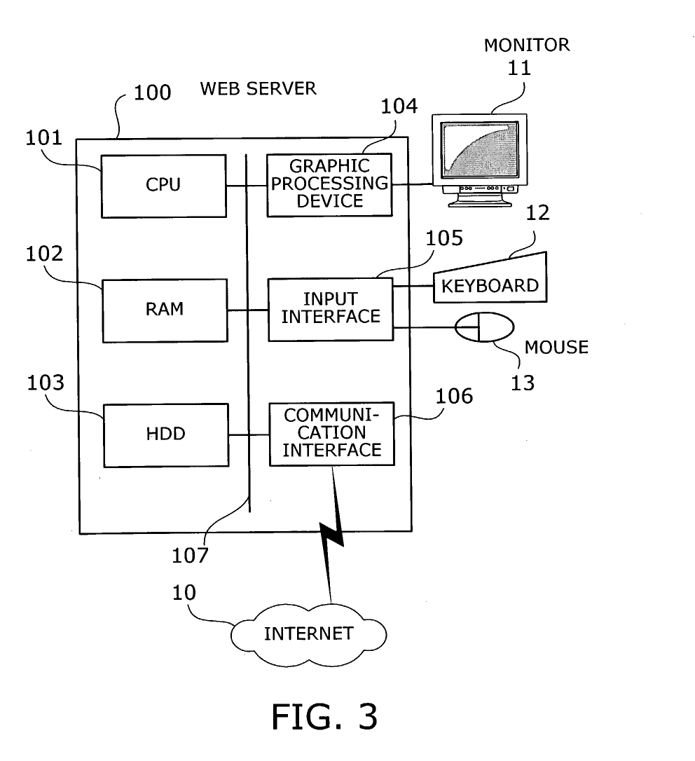

FIG. 3 is a diagram illustrating a hardware construction of the web server used in the embodiment of the present invention. The entire system of the web server 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least a portion of an OS (operating system) program and application programs which are executed by the CPU 101, as well as various types of data necessary for processing by the CPU 101. The HDD 103 stores the OS and the application programs.

A monitor 11 is connected to the graphic processing device 104, which makes the monitor 11 display an image on an screen in accordance with an instruction from the CPU 101. A keyboard 12 and a mouse 13 are connected to the input interface 105, which transmits signals transmitted from the keyboard 12 and the mouse 13, to the CPU 101 through the bus 107.

The communication interface 106 is connected to the Internet 10. The communication interface 106 is provided for exchanging data with other computers through the Internet 10.

By using the above hardware construction, it is possible to realize processing functions in the embodiment of the present invention. In addition, the terminals 21 to 23 can also be realized by using similar hardware constructions.

Next, processing functions of the web server are explained.

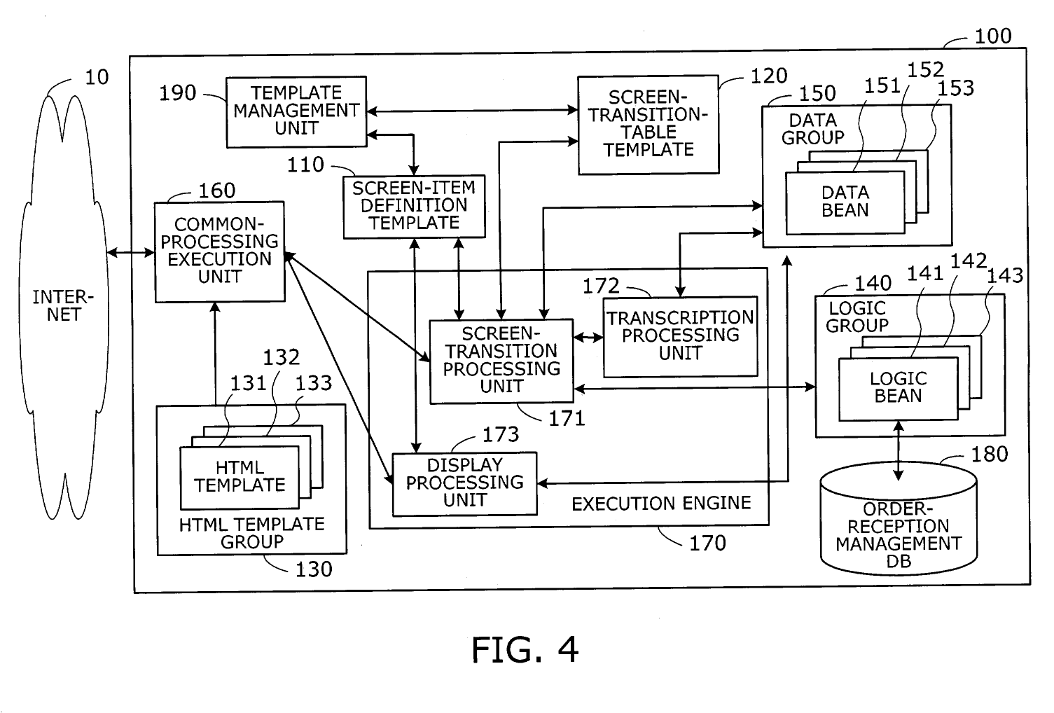

FIG. 4 is a block diagram illustrating the functions of the web server. The web server 100 comprises a screen-item definition template 110, a screen-transition-table template 120, an HTML template group 130, a logic group 140, a data group 150, a common-processing execution unit 160, an execution engine 170, an order-reception management database (DB) 180, and a template management unit 190. There are connection relationships between ones of the above elements between which information is exchanged. That is, the common-processing execution unit 160 is connected to the Internet 10, the HTML template group 130, and the execution engine 170, which is further connected to the screen-item definition template 110, the screen-transition-table template 120, the logic group 140, and the data group 150. The logic group 140 is connected to the order-reception management DB 180, and the template management unit 190 is connected to the screen-item definition template 110 and the screen-transition-table template 120. The above connection relationships are established by making arrangements for exchanging arbitrary information between connected elements.

The screen-item definition template 110 is an information storage portion in which a structure of data to be set as at least one item in each screen is defined.

The screen-transition-table template 120 is an information storage portion in which at least one relationship between at least one button in at least one screen as at least one start of-transition and at least one screen as at least one end of-transition is defined.

The HTML template group 130 is a set of data each of which defines a structure of a display screen having a certain screen type. That is, the HTML template group 130 is a set of HTML templates 131, 132, 133, . . . , in which screen-display forms corresponding to various types of screens are defined. In this embodiment, the HTML templates 131, 132, 133, . . . are document files described in HTML.

The logic group 140 is a set of programs in which procedures of processing performed by the web server 100 according to requests from the terminals 21 to 23 are described. In this embodiment, the respective programs in the logic group 140 are referred to as logic beans 141, 142, 143, . . . . For example, the procedures of processing can be described by using JSP (JavaServer Pages) or the like.

The data group 150 is a data storage portion in which data set in each screen are stored. In this embodiment, data in the respective screens are referred to as data beans 151, 152, 153, . . . . In other words, each of the data beans 151, 152, 153, . . . is a memory area for dynamically displaying data in a screen. In each of the data beans 151, 152, 153, . . . , data to be set in the corresponding screen is stored associated with at least one name of at least one variable (variable name).

The common-processing execution unit 160 transmits and receives information to and from the terminals 21 to 23, and provides content (such as screen data) according to the data beans 151, 152, 153, . . . . Specifically, the common-processing execution unit 160 acquires identification information for identifying a button for a screen transition which is selected in a screen displayed on the terminals 21 to 23. Then, the common-processing execution unit 160 passes to the execution engine 170 the identification information identifying the button, and receives from the execution engine 170 identification information identifying a screen as the end of the transition, where the identification information identifying the button is a combination of identification information identifying the screen in which the button is displayed and the name of the button. Next, the common-processing execution unit 160 acquires from the HTML template group 130 an HTML template corresponding to the identification information identifying the screen as the end of the transition, and further acquires data from the execution engine 170, where the acquired data is in a display form in which the data is to be displayed as at least one item in the acquired HTML template. Further, the common-processing execution unit 160 sets the data acquired from the execution engine 170, in the acquired HTML template, generates document data (an HTML document), and transmits the generated HTML document to one of the terminals 21 to 23.

When processing to be performed on an HTML document by the web server 100 is described by using JSP, the function of the common-processing execution unit 160 can be realized by a program called a JSP container.

The execution engine 170 determines an end-of-transition screen, transcribes data into the end-of-transition screen, and converts data to be displayed, into a display form, according to a request from the common-processing execution unit 160. In order to perform the above processing, the execution engine 170 comprises a screen-transition processing unit 171, a transcription processing unit 172, and a display processing unit 173.

The screen-transition processing unit 171 performs processing for determining an end-of-transition screen. Specifically, when the common-processing execution unit 160 passes identification information identifying a button to the screen-transition processing unit 171, the screen-transition processing unit 171 refers to the screen-transition-table template 120, and determines an end-of-transition screen. Then, the screen-transition processing unit 171 passes identification information (i.e., a screen ID) identifying the end-of-transition screen to the common-processing execution unit 160.

The screen-transition processing unit 171 receives through the common-processing execution unit 160 data (reception-item data) which is set as each item in a start-of-transition screen when a button for changing the screen is pressed in the terminals 21 to 23. When the screen-transition processing unit 171 receives the reception-item data, the screen-transition processing unit 171 acquires a data bean of the start-of-transition screen from the data group 150. Then, the screen-transition processing unit 171 passes to the transcription processing unit 172 a combination of the reception-item data and the data bean of the start-of-transition screen. Thus, the transcription processing unit 172 transcribes the reception-item data into the data bean of the start-of-transition screen.

When the transcription of the reception-item data is normally completed, the screen-transition processing unit 171 acquires the data beans of the start-of-transition screen and the end-of-transition screen from the data group 150, and passes the data beans of the start-of-transition screen and the end-of-transition screen to the transcription processing unit 172. Thus, the transcription processing unit 172 transcribes into the data bean of the end-of-transition screen a portion of the data bean of the start-of-transition screen which is in common with the data bean of the end-of-transition screen.

The transcription processing unit 172 performs processing for determining information to be transcribed into the end-of-transition screen. Specifically, the transcription processing unit 172 receives from the screen-transition processing unit 171 reception-item data transmitted from the terminals 21 to 23, and checks for properness of the data (e.g., whether or not the attribute of the data is proper). In addition, the transcription processing unit 172 registers proper data in the data bean corresponding to the start-of-transition screen displayed on the terminal on the source side. Further, the transcription processing unit 172 checks for properness of the data common to the data beans of the start-of-transition screen and the end-of-transition screen, and registers proper data in the data bean of the end-of-transition screen.

When the display processing unit 173 receives from the common-processing execution unit 160 data to be displayed on a screen, the display processing unit 173 refers to the screen-item definition template 110, and determines a data format for displaying the data. Then, the display processing unit 173 converts the received data into a predetermined data format, and returns the converted data to the common-processing execution unit 160.

The order-reception management DB 180 is a database in which details of orders which are transmitted from the order-receiver companies 32 to 34 are registered. The logic beans 141 included in the logic group 140 performs operations for inputting and outputting data in and from the order-reception management DB 180.

The template management unit 190 edits the contents of the screen-item definition template 110 and the screen-transition-table template 120. For example, the template management unit 190 compares the screen-item definition template 110 with another screen-item definition template and the screen-transition-table template 120 with another screen-transition-table template so as to indicate their differences, and registers the indicated differences in the screen-item definition template 110 and the screen-transition-table template 120.

Next, examples of data structures of the screen-item definition template 110, the screen-transition-table template 120, and the HTML template 131 are explained below.

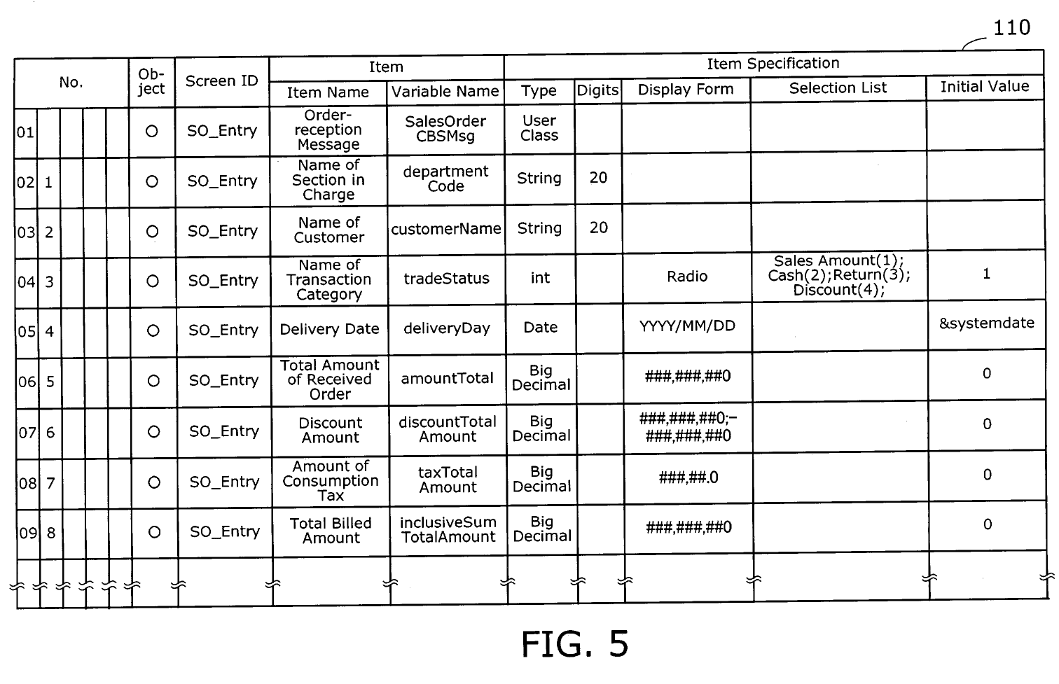

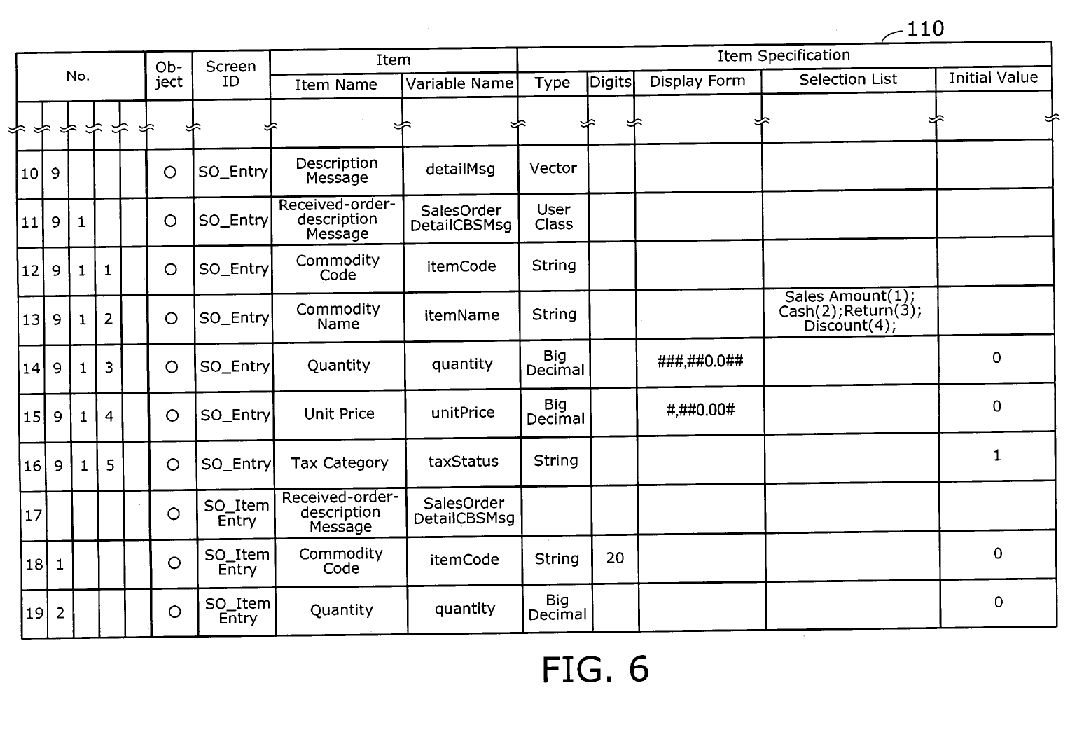

First, the data structure of the screen-item definition template 110 is explained with reference to FIGS. 5 and 6.

FIG. 5 is a first diagram illustrating an example of a data structure of a screen-item definition template, and FIG. 6 is a second diagram illustrating an example of a data structure of a screen-item-definition template. As illustrated in FIGS. 5 and 6, fields of “Record Number (No.),” “Object,” “Screen ID,” “Item,” and “Item Specification” are provided in the screen-item definition template 110. The information items indicated in each row of the screen-item definition template in FIG. 5 are associated with each other, and a set of information items indicated in each row constitute a record.

In the field “Record Number,” an identification number of each record is set.

In the field “Object,” a flag indicating whether or not items in each record are to be displayed is set. In this embodiment, a single circle is set for a record to be displayed. When a record is not to be displayed, the field of the object for the record is left blank. When the screen-item definition template 110 is produced by using another screen-item definition template as a base, a double circle is set for a record which is added to the screen-item definition template used as the base.

In the field “Screen ID,” a screen ID of a screen in which items in each record are displayed is set.

In the field “Item,” identification information identifying each item is set. The field “Item” is divided into subfields of “Item Name” and “Variable Name.” In the subfield “Item Name,” names of the items are set. In the subfield “Variable Name,” variable names each uniquely identifying an item is set.

In the field “Item Specification,” a data format of each item is set. The field “Item Specification” is divided into subfields of “Type,” “Number of Digits,” “Display Form,” “Selection List,” and “Initial Value.”

In the field “Type,” a type of data which can be registered as each item is set. The type of data may be “User Class,” “String,” “int,” “Date,” “BigDecimal,” “Vector,” and the like. The type “User Class” is a type of data defined by a user, the type “String” denotes a character string, the type “int” denotes an integer, the type “Date” denotes a date, the type “BigDecimal” denotes a decimal number, and the type “Vector” denotes a data structure which allows putting an element in or taking out an element from a designated position.

In the field “Number of Digits,” a size of data which can be inputted is set as the numbers of digits. In the case where the data type is “String,” the maximum length of the character string is defined by the number of digits.

In the field “Display Form,” information defining a display form of data registered in each item is set. For example, when the display form is “Radio,” the screen has a form having a radio button. When the display form is “YYYY/MM/DD,” data of a date which includes a year, a month, and a day separated with slashes (/) and arranged in this order is displayed. When the display form is “###,###,##0,” data has a form “###,###,##0” in which each symbol # represents a number.

When an item includes a selection branch, a list of objects to be selected is set in the field “Selection List.” For example, in the field “Selection List” for the record having the recording number “04, 3,” data “sales amount (1),” “cash (2),” “returns (3),” and “discount (4)” are set.

In the field “Initial Value,” an initial value of each item can be set. The initial value is an arbitrary numerical value or function. An example of the function is “&systemdate,” which is a function for acquiring date information from an internal clock in the web server 100.

Next, the screen-transition-table template is explained below.

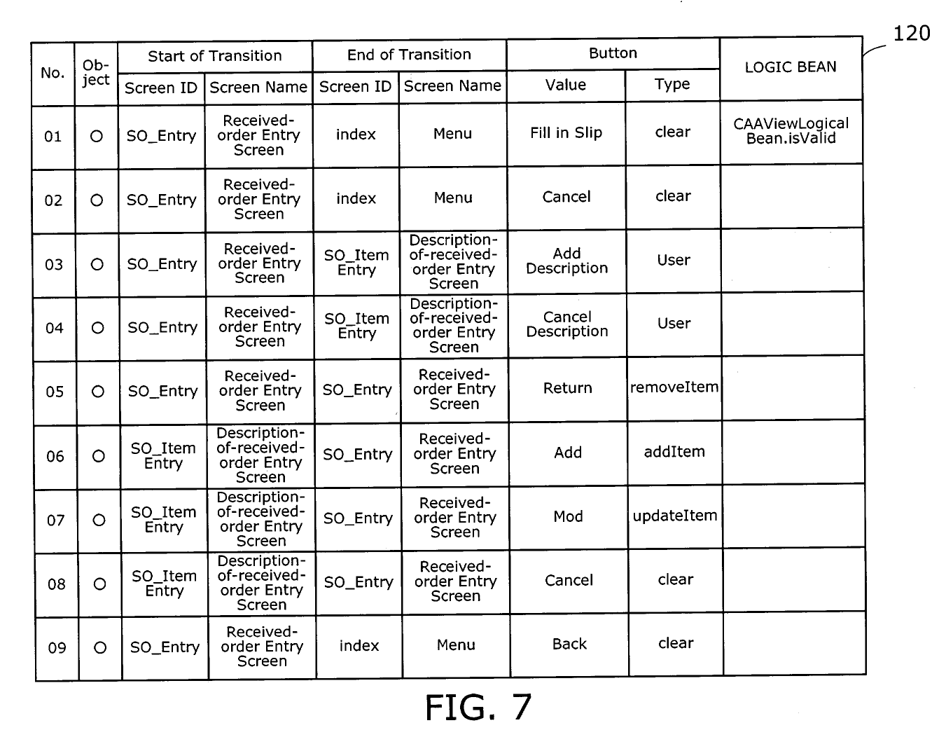

FIG. 7 is a diagram illustrating an example of a data structure of the screen-transition-table template. In the screen-transition-table template 120, information on at least one correspondence between at least one end-of-transition screen and at least one start-of-transition screen at the time a button in the screen is pressed is set, where the button may be an indication of an anchor which indicates a link. The screen-transition-table template 120 includes fields of “Screen-transition Record Number (No.),” “Object,” “Start of Transition,” “End of Transition,” “Button,” and “Logic Bean.” The information items indicated in each row of the screen-item definition template in FIG. 5 are associated with each other.

In the field “Screen-transition Record Number,” an identification number uniquely identifying each button in each start-of-transition screen is set.

In the field “Object,” a flag indicating whether or not a screen transition corresponding to each button is to be made is set. In this embodiment, a single circle is set for a button corresponding to which a screen transition is to be made. When a button corresponding to which a screen transition is not to be made, the field of the object for the button is left blank. When the screen-transition-table template 120 is produced by using another screen-transition-table template as a base, a double circle is set for an item which is added to the screen-item definition template used as the base.

In the field “Start of Transition,” information for uniquely identifying a screen as a start of-transition is set.

The field “Start of Transition” is divided into subfields of “Screen ID” and “Screen Name.” In the subfield “Screen ID,” identification information identifying a screen as a start of-transition is set. In the subfield “Screen Name,” a name of a screen as a start of-transition is set.

In the field “End of Transition,” information for uniquely identifying a screen as an end of transition is set.

The field “End of Transition” is divided into subfields of “Screen ID” and “Screen Name.” In the subfield “Screen ID,” identification information identifying a screen as an end of-transition is set. In the subfield “Screen Name,” a name of a screen as an end of-transition is set.

In the field “Button,” information for uniquely identifying a button in a screen as a start of transition is set. The field “Button” is divided into subfields of “Value” and “Type.” In the subfield “Value,” identification information identifying each button is set. In the field “Type,” a type of transcription of information performed in response to pressing of each button is set as a button type.

The button type indicates a variation for realizing automatic transcription of at least one value of at least one screen item common to a data bean corresponding to a start-of-transition screen and a data bean corresponding to an end-of-transition screen. That is, the button type is provided for automating the processing for transcription between identical items in two data areas. Conventionally, this processing requires redundant operations in which programming is performed every time the construction of the screen is changed. There are five data types: 1) User; 2) addItem; 3) removeItem; 4) updateItem; and 5) clear.

1) The data type “User” indicates that no transcription is performed by the transcription processing unit 172. The transcription processing unit 172 has an outlet (an interface for data input and output) to a user program so that the transcription processing unit 172 can delegate the transcription processing to a program of each user. When “User” is set as the data type, the processing for transcribing data is delegated to an arbitrary program of a user. In addition, the transcription processing unit 172 is provided with a default outlet to a user program, so that it is possible to copy or clear a data bean of an end-of-transition screen in the definitions of the screen-transition-table template by using a program prepared as the default outlet.

2) The data type “addItem” indicates automatic processing for inserting a data bean of a start-of-transition screen into a data bean of an end-of-transition screen so as to increase the ratio between the numbers of data items having an identical variable name in the data beans of the end-of-transition screen and the start-of-transition screen from n:1 to n+1:1. For example, this processing is performed in order to insert one line in a displayed form of a table of commodities in a received-order entry screen when the number of pieces of a certain commodity is inserted in a description-of-received-order entry screen.

3) The data type “removeItem” indicates automatic processing for removing a data bean of a start-of-transition screen from a data bean of an end-of-transition screen so as to decrease the ratio between the numbers of data items having an identical variable name in the data beans of the end-of-transition screen and the start-of-transition screen from n:1 to n−1:1. For example, according to this processing, at least one data item in a data bean of an end-of-transition screen which is identical to at least one data item in a data bean of a start-of-transition screen is removed.

4) The data type “updateItem” indicates processing for updating one of n data items in a data bean of an end-of-transition screen with a data item in a data bean of a start-of-transition screen when the ratio between the numbers of data items having an identical variable name in the data beans of the end-of-transition screen and the start-of-transition screen is n:1.

5) The data type “clear” indicates processing for clearing a data area corresponding to a start-of-transition screen before transition. After this processing, subsequent processing is performed. Even after display of a screen is completed, the execution engine 170 continues to hold a data bean corresponding to the screen. Therefore, when the data bean of the start-of-transition screen is cleared at the time of-transition to another screen, it is possible to prevent redisplay of previous data.

In the field “Logic Bean,” identification information for identifying a logic bean which is executed at the time of pressing of a button is set. For example, a logic bean for registering a received order in the order-reception management DB 180 by using values inputted into the screen is set for the “Fill in Slip” button in the received-order entry screen. In addition, since the button type is “clear,” the received-order entry screen is returned to the state before the input (i.e., cleared screen).

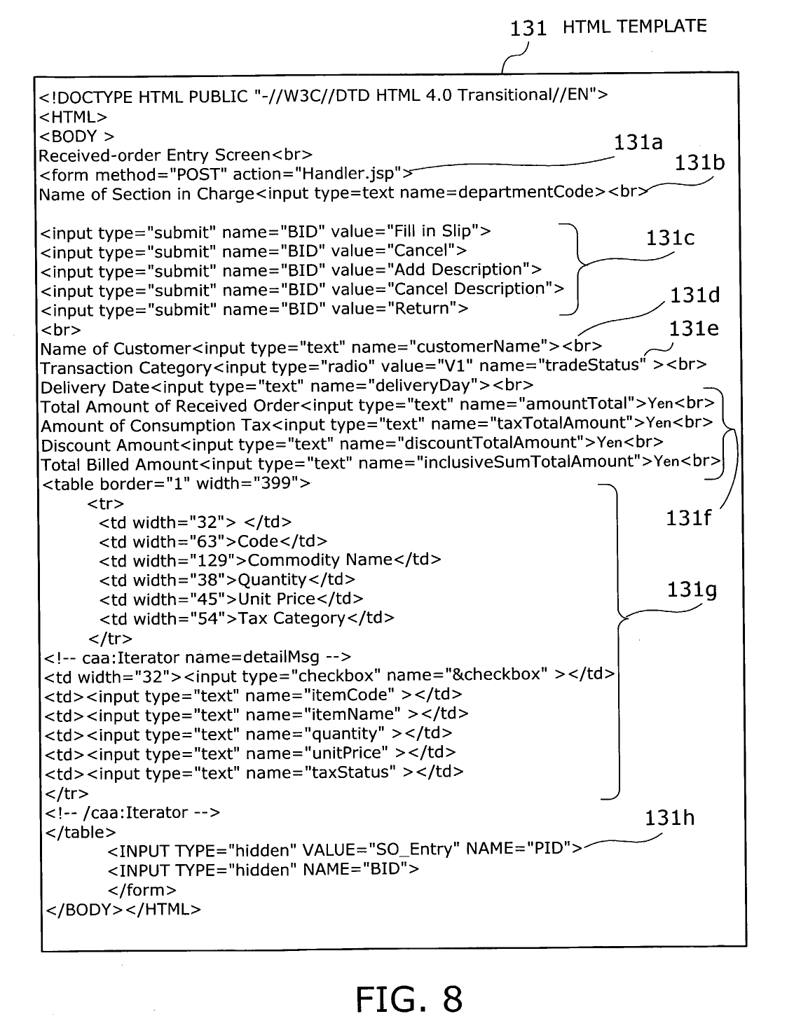

FIG. 8 is a diagram illustrating an example of an HTML template. The HTML template illustrated in FIG. 8 is an HTML template 131 for a received-order entry screen. The HTML template 131 is a structured document described in HTML.

In the HTML template 131, destination-designation information 131a, first input-item information 131b, button information 131c, second input-item information 131d, radiobox information 131e, third input-item information 131f, table-display information 131g, and screen-ID-definition information 131h are described.

The destination-designation information 131a indicates that form data is transmitted to an URL (Uniform Resource Locator) designated by an action attribute. In FIG. 8, the URL “Handler.jsp” designated by the action attribute is the URL of the web server 100.

The first input-item information 131b indicates that a textbox for input of a name of a section in charge is displayed.

The button information 131c indicates that transmission buttons are displayed. In the example of FIG. 8, a field name “BID” is assigned to a plurality of transmission buttons. In addition, button names of the respective transmission buttons are defined by the “value” attributes. The defined button names are “Fill in Slip,” “Cancel,” “Add Description,” “Cancel Description,” and “Return.” The same values as the values of the buttons in the corresponding records in the screen-transition-table template 120 are set as the “value” attributes.

The second input-item information 131d indicates that a textbox for input of a name of a customer is displayed.

The radiobox information 131e indicates that a radiobox for selection of a transaction category is displayed. In the radiobox information 131e, “tradeStatus” is set as a field name.

The third input-item information 131f indicates that a textbox for input of a delivery date, a total amount of a received order, an amount of consumption tax, a total billed amount, and a reception schedule of goods are displayed with a checkbox.

The screen-ID-definition information 131h defines a screen ID (PID) of an HTML document produced based on the HTML template 131. In the example of FIG. 8, the screen ID is “S0_Entry.”

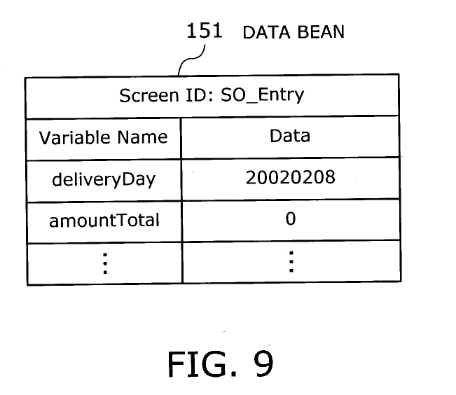

FIG. 9 is a diagram illustrating an example of a data structure of a data beans. In the data bean 151, a screen ID of a screen corresponding to the data bean is set. In the example of FIG. 9, the screen ID “S0_Entry” of the received-order entry screen is set. In the data bean 151, variable names and data of items displayed in the screen are set in such a manner that the variable name of each item is associated with the data of the item. In the example of FIG. 9, the variable name “deliveryDay” and data “20020208” (indicating Feb. 8, 2002) of the delivery date, the variable name “amountTotal” and data “0” of the total amount of the received order, and the like are set.

When the web server 100 having the construction illustrated in FIG. 4 holds the data having structures as illustrated in FIGS. 5 to 9, the web server 100 can receive orders through Internet 10. Hereinbelow, processing performed by the web server 100 are explained in detail in an exemplary case where the terminal 21 accesses the web server 100.

For example, when a customer accesses the web server 100 by using the terminal 21, a menu screen is displayed on the terminal 21. When the customer chooses an item of reception of commodity orders, the common-processing execution unit 160 and the execution engine 170 cooperate to produce an HTML document of a received-order entry screen based on the HTML template 131 for the received-order entry screen. In this embodiment, a transition from the received-order entry screen to a description-of-received-order entry screen is made so as to enable input of information on details of a received order. When information on details of the received order is input into the description-of-received-order entry screen, and an addition button is pressed, the transition to the received-order entry screen is made. At this time, the information input into the description-of-received-order entry screen is transcribed into the received-order entry screen. Thus, a received-order entry screen including the information input into the description-of-received-order entry screen is displayed on the terminal 21.

A sequence of processing is briefly explained below by an exemplary case where a transition from a description-of-received-order entry screen to a received-order entry screen is made.

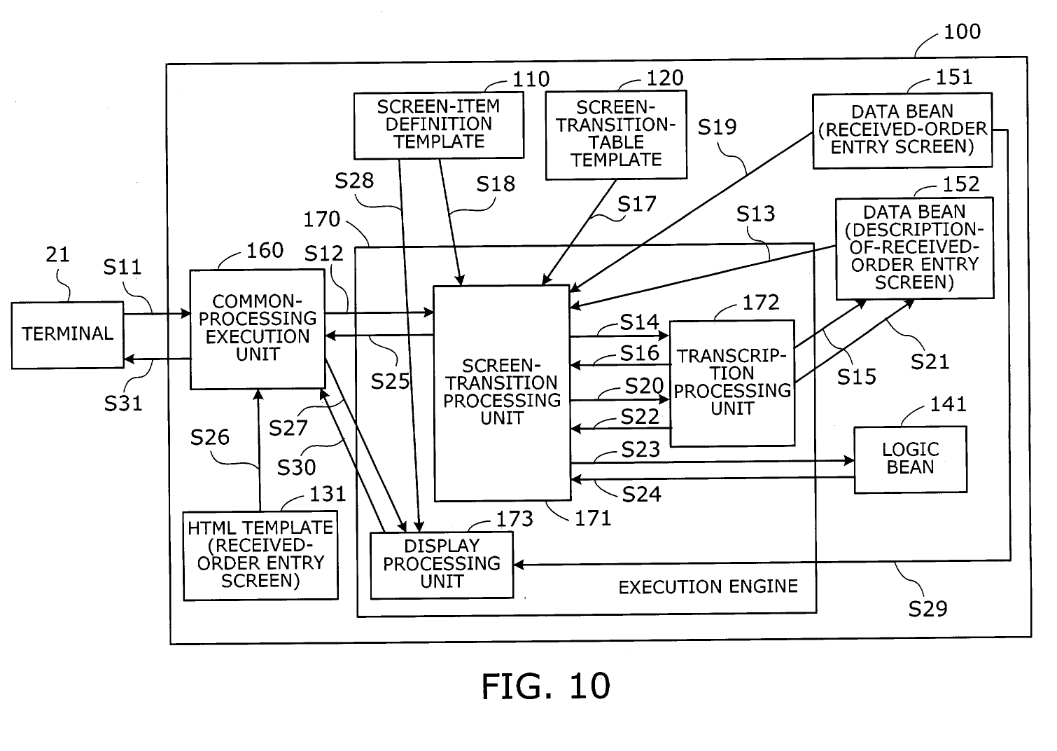

FIG. 10 is a conceptual diagram illustrating a flow of information at the time of screen transition. In FIG. 10, it is assumed that the data bean 151 corresponds to a received-order entry screen, and the data bean 152 corresponds to a description-of-received-order entry screen.

For the purpose of illustration, an exemplary case where the addition button is pressed in the description-of-received-order entry screen displayed by a browser on the terminal 21 is explained. First, the terminal 21 transmits to the web server 100 identification information (i.e., a screen ID) identifying the description-of-received-order entry screen, identification information (i.e., a “value” attribute) identifying the addition button, and data (reception-item data) inputted into each item (in step S11). The common-processing execution unit 160 in the web server 100 receives the transmitted information, and passes the received information to the screen-transition processing unit 171 in the execution engine 170 (in step S12).

The screen-transition processing unit 171 acquires the data bean 152 corresponding to the description-of-received-order entry screen (in step S13). Next, the screen-transition processing unit 171 passes the reception-item data and the data bean 152 to the transcription processing unit 172 (in step S14).

The transcription processing unit 172 matches up the reception-item data with the data bean 152 item by item, and checks for properness of the data. When the data is proper, the transcription processing unit 172 registers in the data bean 152 data of each item in the reception-item data (in step S15). Thereafter, the transcription processing unit 172 sends a processing result (indicating whether or not the data is successfully registered) to the screen-transition processing unit 171 (in step S16).

Next, the screen-transition processing unit 171 refers to the screen-transition-table template 120, and determines an end-of-transition screen (in step S17). Specifically, the screen-transition processing unit 171 searches the screen-transition-table template 120 for a record corresponding to a combination of the identification information (screen ID) identifying the end-of-transition screen and the identification information (the “value” attribute) identifying the pressed button, which are transmitted from the terminal 21. Then, the screen-transition processing unit 171 acquires, from the record searched for, identification information (i.e., a screen ID) identifying a screen as an end of transition and identification information (the “value” attribute) identifying a logic bean. In the example of FIG. 7, a record having a screen transition record number (No.) “06” is detected, and a screen ID as the end of transition is determined to be “S0_Entry,” which is a screen ID set in the received-order entry screen.

When the end-of-transition screen is determined, the screen-transition processing unit 171 refers to a screen-item definition template 110, and acquires at least one variable name contained in the end-of-transition screen (in step S18). Next, the screen-transition processing unit 171 acquires the data bean 151 corresponding to the received-order entry screen as the end-of-transition screen based on the at least one variable name (in step S19). In addition, the screen-transition processing unit 171 passes to the transcription processing unit 172 the data bean 152 acquired in step S13 and the data bean 151 acquired in step S19. (in step S20).

The transcription processing unit 172 compares items of the data beans 151 and 152 so as to search for at least one matched item, and checks for properness of the data. When the data is proper, the transcription processing unit 172 registers in (transcribes into) the data bean 151 the data of each item included in the reception-item data (in step S21). Thereafter, the transcription processing unit 172 sends a processing result (indicating whether or not the data is successfully registered) to the screen-transition processing unit 171 (in step S22).

The screen-transition processing unit 171 determines the logic bean 141 to be executed, based on the identification information identifying the logic bean and being acquired in step S17, and passes the data bean 151 acquired in step S19 to the determined logic bean 141 (in step S23). Then, the logic bean 141 performs processing of data in the data bean 151, and passes a processing result to the screen-transition processing unit 171 (in step S24). Since, in the example of FIG. 7, no logic bean is set in the record having the screen transition record number (No.) “06,” the processing in steps S23 and S24 is not performed.

Thereafter, the screen-transition processing unit 171 passes to the common-processing execution unit 160 the screen ID “S0_Entry” of the end-of-transition screen (received-order entry screen) acquired in step S17 (in step S25). The common-processing execution unit 160 acquires an HTML template 131 corresponding to the received-order entry screen (in step S26). In addition, the common-processing execution unit 160 interprets contents of the HTML template 131. Every time the common-processing execution unit 160 detects an item the data of which is to be displayed, the common-processing execution unit 160 sends to the display processing unit 173 identification information (a variable name) identifying the item (in step S27).

The display processing unit 173 refers to the screen-item definition template 110 (in step S28), and determines a requirement for display of the item corresponding to the identification information sent from the common-processing execution unit 160. Next, the display processing unit 173 acquires data of the corresponding item from the data bean 151 corresponding to the received-order entry screen as the end of transition (in step S29), and changes data according to the requirement for display. Then, the display processing unit 173 passes to the common-processing execution unit 160 data which complies with the requirement for display (in step S30).

The common-processing execution unit 160 replaces data of at least one item in the HTML template 131 corresponding to the data received from the display processing unit 173, with the data received from the display processing unit 173. When the common-processing execution unit 160 receives from the display processing unit 173 data for display of all items, and adds the data to the HTML template 131, an HTML document which defines a structure of the received-order entry screen and is to be passed to the terminal 21 is generated. The common-processing execution unit 160 transmits the generated HTML document through the Internet 10 to the terminal 21 (in step S31). Then, the received-order entry screen is displayed on the terminal 21.

Next, an example of screen transition is explained below. In the following example, a transition from a received-order entry screen to a description-of-received-order entry screen is made, data is inputted, and another transition to the received-order entry screen is made.

Incidentally, the terminal 21 can display objects to be displayed on a window arranged in a screen. In the window transition in this embodiment, the start-of-transition window may be dismissed be left displayed when the end-of-transition window is displayed. In either case, the end-of-transition window becomes active, i.e., the end-of-transition window enters a state in which the end-of-transition window can receive user's manipulation.

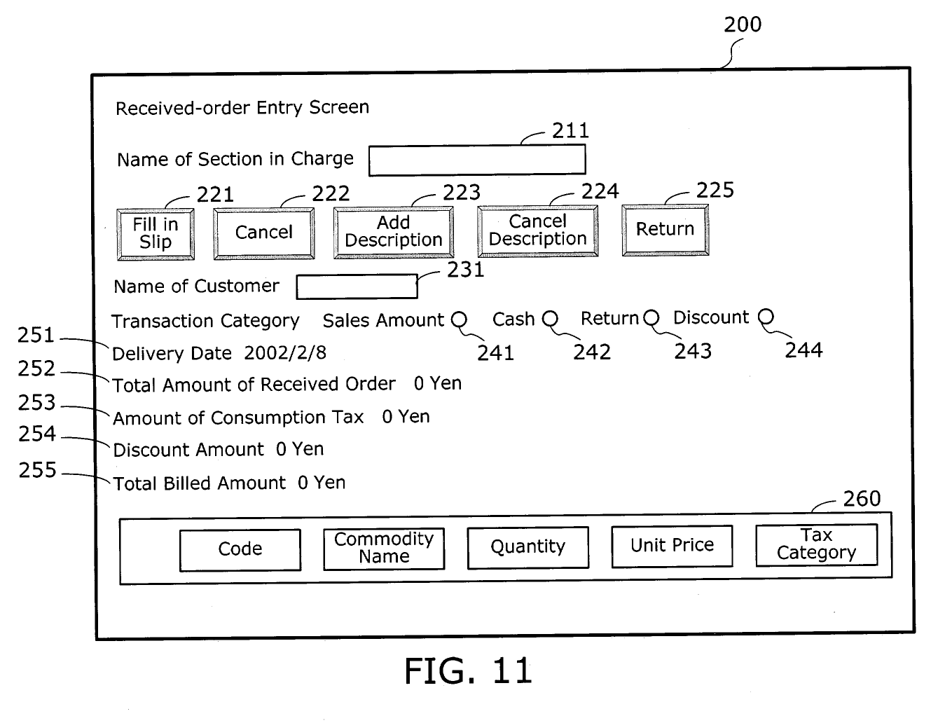

FIG. 11 is a diagram illustrating an example of the received-order entry screen in an initial state. The received-order entry screen 200 includes a name-of-section-in-charge input area 211, a fill-in-slip button 221, a cancel button 222, an add-description button 223, a cancel-description button 224, a return button 225, a customer-name input area 231, an amount-of-sales-selection radio button 241, a cash-selection radio button 242, a return-selection radio button 243, a discount-selection radio button 244, a delivery-date display area 251, an amount-of-received-order display area 252, an amount-of-consumption-tax display area 253, a discount-amount display area 254, a total-billed-amount display area 255, and a description-of-received-order display area 260.

The name-of-section-in-charge input area 211 is a textbox for inputting a name of a section in charge.

The fill-in-slip button 221 is a button for entering the current settings on a received order. When the fill-in-slip button 221 is pressed, information which is set in the received-order entry screen 200 at the time of the pressing is transmitted to the web server 100, and registered in the order-reception management DB 180.

The cancel button 222 is a button for cancelling the information set in the received-order entry screen 200. When the cancel button 222 is pressed, the information set in the received-order entry screen 200 is cancelled, or initial values are set in the received-order entry screen 200.

The add-description button 223 is a button for adding a commodity to descriptions of the received order. When the add-description button 223 is pressed, the screen transitions to the description-of-received-order entry screen.

The cancel-description button 224 is a button for cancelling addition processing for adding a commodity to the descriptions of the received order. When the cancel-description button 224 is pressed, a description of a commodity selected in the description-of-received-order display area 260 is deleted.

The return button 225 is a button for returning the current screen to a menu screen. When the return button 225 is pressed, the screen transitions to the menu screen without change in the entry of information on the received order.

The customer-name input area 231 is a textbox for inputting a name of a company which receives an order.

The amount-of-sales-selection radio button 241, the cash-selection radio button 242, the return-selection radio button 243, and the discount-selection radio button 244 are radio buttons for selecting a transaction category. It is possible to select one of these radio buttons.

The delivery-date display area 251 is an area for displaying a delivery date, which is preset. The amount-of-received-order display area 252 is an area for displaying a total amount of a received order, which is preset. The amount-of-consumption-tax display area 253 is an area for displaying an amount of consumption tax, which is preset. The discount-amount display area 254 is an area for displaying a discount amount, which is preset. The total-billed-amount display area 255 is an area for displaying a total billed amount, which is preset.

The description-of-received-order display area 260 is an area for displaying information on commodities registered in descriptions of the received order. In the description-of-received-order display area 260, data of a commodity code, a commodity name, a quantity, a unit price, and a tax category are displayed for each commodity. Since no commodity is registered in the example of FIG. 11, no commodity information is displayed in the description-of-received-order display area 260.

When a user of the terminal 21 presses the add-description button 223 in order to add a commodity to the entries of the descriptions of a received order, the screen of the terminal 21 transitions to the description-of-received-order entry screen.

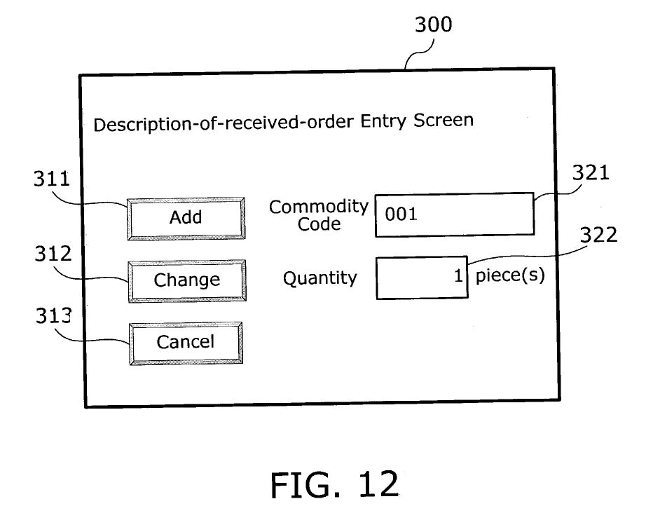

FIG. 12 is a diagram illustrating an example of the description-of-received-order entry screen. The description-of-received-order entry screen 300 includes an addition button 311, a change button 312, a cancel button 313, a commodity-code input area 321, and a quantity input area 322.

The addition button 311 is a button for adding a designated commodity to entries of descriptions of a received order in the description-of-received-order entry screen 300. When the addition button 311 is pressed, information inputted into the commodity-code input area 321 and the quantity input area 322 is transmitted to the web server 100, and the screen transitions to the received-order entry screen.

The change button 312 is a button for changing the quantity of a designated commodity in the description-of-received-order entry screen 300. When the change button 312 is pressed, information inputted into the commodity-code input area 321 and the quantity input area 322 is transmitted to the web server 100, and the screen transitions to the received-order entry screen.

The cancel button 313 is a button for going to the received-order entry screen without processing such as addition of a commodity to the entries of the descriptions of the received order. When the cancel button 313 is pressed, the screen transitions to the received-order entry screen.

The commodity-code input area 321 is a textbox for inputting a commodity code of a commodity to be registered in the entries of the descriptions of the received order, and the quantity input area 322 is a textbox for inputting a quantity of a commodity the order of which is received.

Consider an exemplary case where only a toner kit (having a commodity code “001”) is added to the description-of-received-order entry screen 300 as an ordered commodity. In this case, the user of the terminal 21 inputs “001” into the commodity-code input area 321 and “1” into the quantity input area 322, and presses the addition button 311. Then, information on the commodity code and the quantity is transmitted to the web server 100, and a received-order entry screen into which the information input into the description-of-received-order entry screen 300 is transcribed is displayed on the terminal 21.

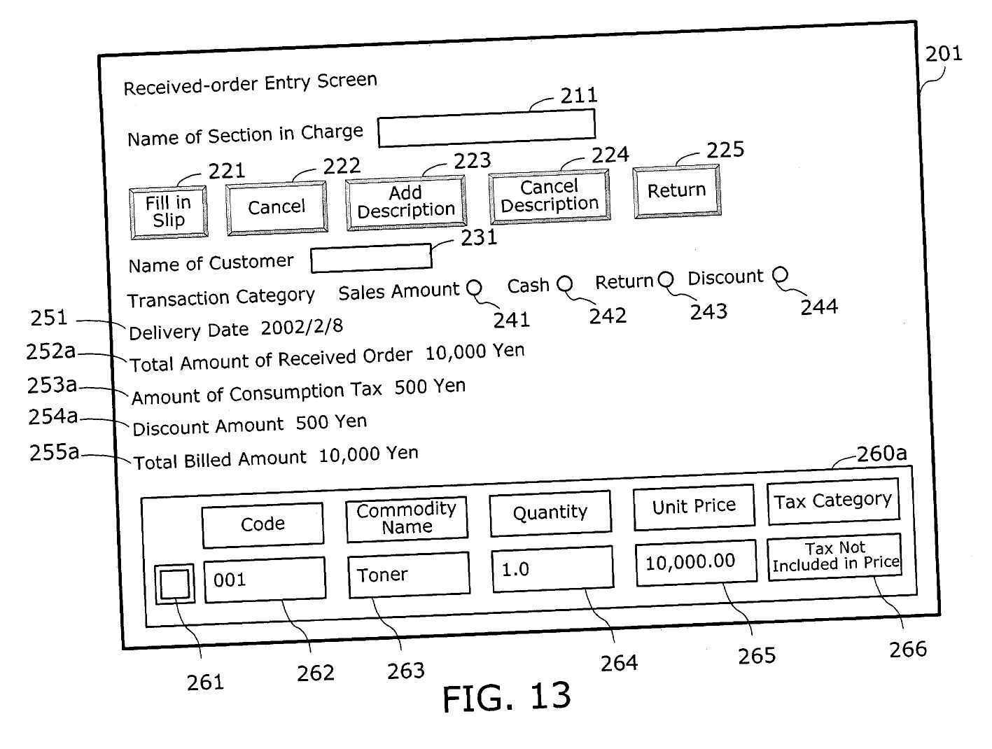

FIG. 13 is a diagram illustrating an example of the received-order entry screen after addition to the entries of the descriptions of the received order. Each data item changed according to the information added to the description-of-received-order entry screen 300 is transcribed into the received-order entry screen 201 after addition to the entries of the descriptions of the received order. In the received-order entry screen 201 illustrated in FIG. 13, the same elements as the elements in the received-order entry screen 200 illustrated in FIG. 11 bear the same reference numerals as FIG. 11, respectively, and therefore the explanations on the same elements are not repeated.

Due to the addition of the description of the toner kit, the total amount of the received order in the amount-of-received-order display area 252a in the received-order entry screen 201 is changed to “10,000 yen.” Similarly, the indication in the amount-of-consumption-tax display area 253a is changed to “500 yen,” the indication in the discount-amount display area 254a is changed to “500 yen,” and the indication in the total-billed-amount display area 255a is changed to “10,000 yen.”

The description-of-received-order display area 260a includes a checkbox 261, a code display area 262, a commodity-name display area 263, a quantity display area 264, a unit-price display area 265, and a tax-category display area 266. The checkbox 261 is provided for indicating whether or not a commodity registered in the entries of the descriptions of the received order is selected. For example, when the cancel-description button 224 is pressed in the situation in which the checkbox 261 is checked, descriptions of the received order corresponding to the checkbox 261 become an object to be deleted.

The code display area 262 indicates a commodity code “001” of the commodity registered in the entries of the descriptions of the received order. The commodity-name display area 263 indicates the name “toner” of the commodity registered in the entries of the descriptions of the received order. The quantity display area 264 indicates the quantity “1.0” of the commodity registered in the entries of the descriptions of the received order. The unit-price display area 265 indicates the unit price “10,000.00” of the commodity registered in the entries of the descriptions of the received order. The tax category 266 indicates the tax category “tax not included in price (sotozei)” of the commodity registered in the entries of the descriptions of the received order.

The data inputted into the description-of-received-order entry screen 300 are transcribed into and displayed in the code display area 262 and the quantity display area 264. Since the entries of the descriptions of the received order are updated by the addition, the values of the respective items (such as the to total amount of the received order) are changed.

Hereinbelow, details of an HTML document generated by the web server 100 are explained in order to display the received-order entry screen 201 of FIG. 13 on the terminal 21.

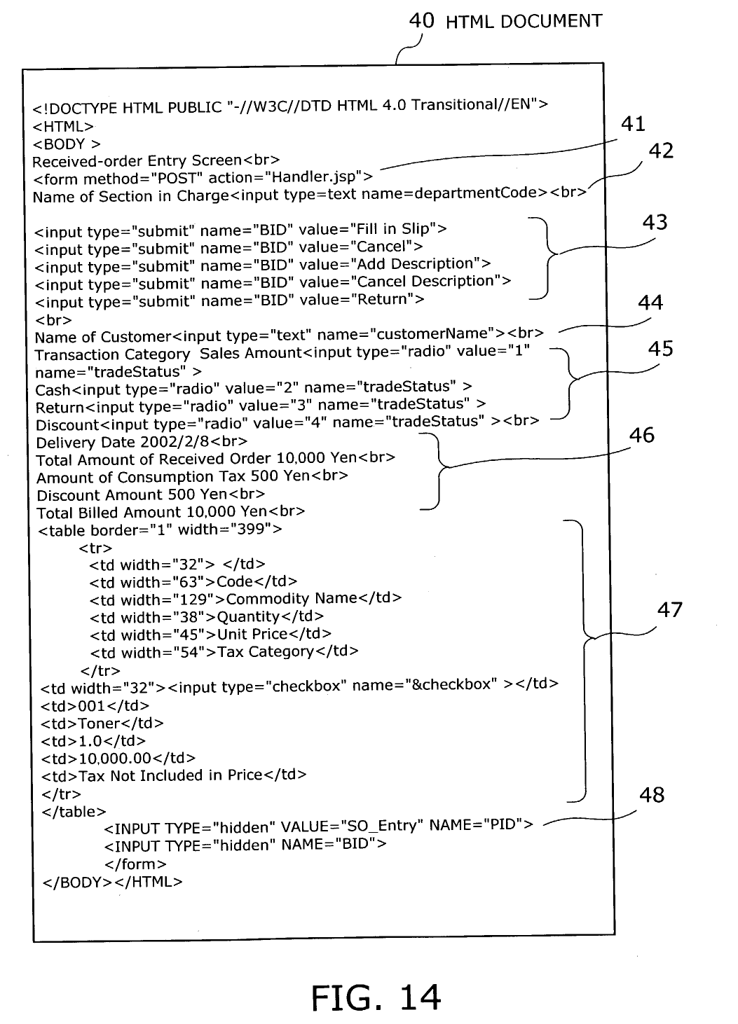

FIG. 14 is a diagram illustrating an example of the HTML document. In the HTML document 40 for the received-order entry screen, destination-designation information 41, first input-item information 42, button information 43, second input-item information 44, radiobox information 45, third input-item information 46, table-display information 47, and screen-ID-definition information 48 are described. The details of the destination-designation information 41, the first input-item information 42, the button information 43, the second input-item information 44, and the screen-ID-definition information 48 are the same as the details of the destination-designation information 131a, the first input-item information 131b, the button information 131c, the second input-item information 131d, and the screen-ID-definition information 131h, respectively.

The radiobox information 45 indicates that a radiobox for selecting a transaction category is displayed. The HTML document 40 indicates that a radiobox including the elements (amount of sales, cash, return, and discount) which are set in the field “Selection List” for the record having the record number “04.3” in the screen-item definition template 110 illustrated in FIG. 5 is displayed.

The third input-item information 46 indicates that data registered as the delivery date, the total amount of the received order, the amount of consumption tax, and the total billed amount are displayed. In the example of FIG. 14, the total amount of the received order “10,000 yen,” the amount of the consumption tax “500 yen,” the discount amount “500 yen,” and the total billed amount “10,000 yen” are set as the data to be displayed.

The table-display information 47 indicates that a code of a received order, a commodity name, a quantity, a unit price, and a tax category, which are registered, are displayed with a checkbox. In the example of FIG. 14, a code “001,” a commodity name “toner,” a quantity “1.0,” a unit price “10,000.00,” and a tax category “tax not included in price” are set for display.

When the above HTML document is passed to the terminals 21 to 23, the received-order entry screen 201 can be displayed on monitors of the terminals 21 to 23.

Next, details of processing performed by the execution engine are explained.

First, processing performed by the screen-transition processing unit 171 is explained.

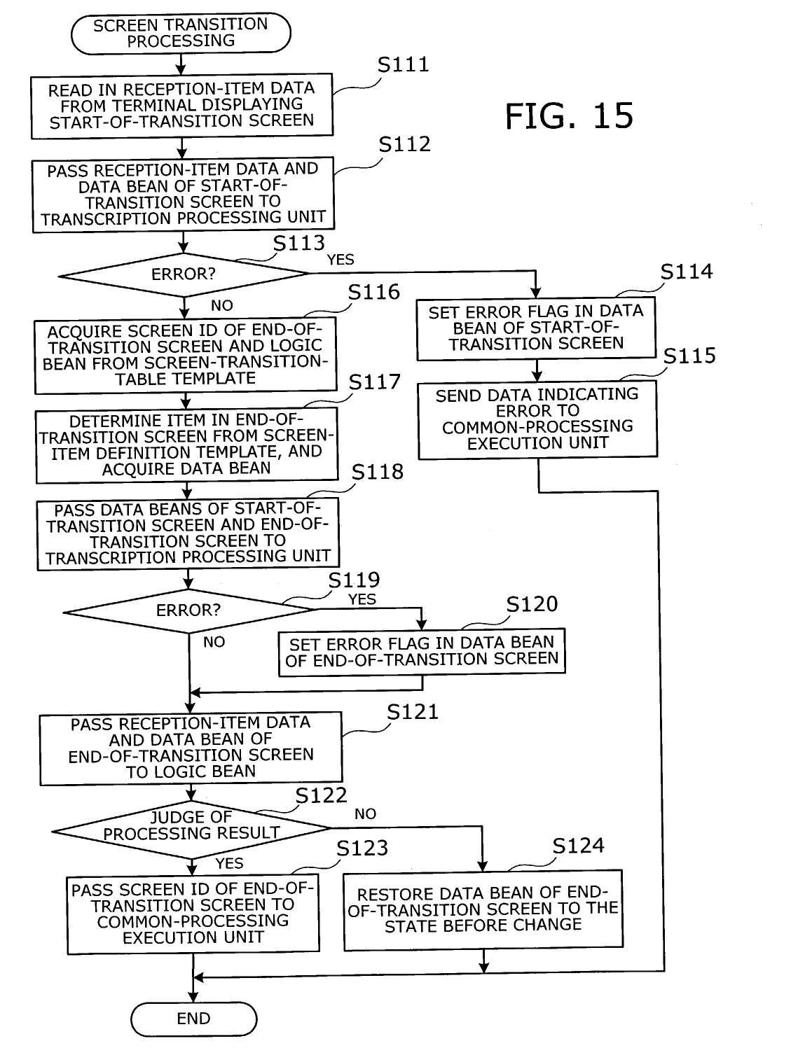

FIG. 15 is a flowchart of a sequence of processing for screen transition. The processing illustrated in FIG. 15 is explained below step by step. The following processing is performed when an arbitrary button in a start-of-transition screen on the terminal 21 is pressed, and data (reception-item data) set in the start-of-transition screen, identification information (i.e., a screen ID) identifying a screen, and identification information (i.e., a “value” attribute) identifying the pressed button are transmitted. The identification information identifying the screen and the identification information identifying the button are defined in the HTML document for the screen displayed on the terminal 21.

[Step S111] The screen-transition processing unit 171 reads in reception-item data from the terminal 21 displaying the start-of-transition screen.

[Step S112] The screen-transition processing unit 171 acquires from the data group 150 a data bean of the start-of-transition screen. Then, the screen-transition processing unit 171 passes to the transcription processing unit 172 the reception-item data and the data bean of the start-of-transition screen.

[Step S113] The screen-transition processing unit 171 determines whether or not the transcription processing unit 172 returns an error. When an error is returned, the operation goes to step S114. When an error is not returned, the operation goes to step S116.

[Step S114] The screen-transition processing unit 171 sets an error flag in the data bean of the start-of-transition screen.

[Step S115] The screen-transition processing unit 171 sends data indicating an error to the common-processing execution unit 160. Then, the common-processing execution unit 160 transmits information indicating an error to the terminal 21, and an error message is displayed on the screen of the terminal 21. Thereafter, the processing is completed.

[Step S116] The screen-transition processing unit 171 acquires from the screen-transition-table template 120 a screen ID of an end-of-transition screen and identification information identifying a logic bean. That is, the screen-transition processing unit 171 extracts from the screen-transition-table template 120 a record corresponding to a combination of the screen ID of the start-of-transition screen and the identification information identifying the button (which are sent from the terminal 21), and acquires the screen ID of the end-of-transition screen and the identification information identifying the logic bean included in the extracted record.

[Step S117] The screen-transition processing unit 171 determines at least one item in the end-of-transition screen from the screen-item definition template 110, and acquires a data bean from the data group 150.

[Step S118] The screen-transition processing unit 171 passes to the transcription processing unit 172 the data bean of the start-of-transition screen and the data bean of the end-of-transition screen.

[Step S119] The screen-transition processing unit 171 determines whether or not the transcription processing unit 172 returns an error. When an error is returned, the operation goes to step S120. When an error is not returned, the operation goes to step S121.

[Step S120] The screen-transition processing unit 171 sets an error flag in the data bean of the end-of-transition screen.

[Step S121] The screen-transition processing unit 171 passes the reception-item data and the data bean of the end-of-transition screen to the logic bean corresponding to the identification information acquired in step S116.

[Step S122] The screen-transition processing unit 171 judges of a result of processing performed by the logic bean. When the result is true, the operation goes to step S123. When the result is false, the operation goes to step S124.

[Step S123] The screen-transition processing unit 171 passes the screen ID of the end-of-transition screen to the common-processing execution unit 160. Thereafter, the processing is completed.

[Step S124] The screen-transition processing unit 171 restores the data bean of the end-of-transition screen to the state before the change (i.e., the state before the transcription processing is performed in step S118). Thereafter, the processing is completed.

Next, the processing performed by the transcription processing unit 172 is explained. The processing performed by the transcription processing unit 172 includes processing for transcribing the reception-item data sent from the terminal 21 into the data bean of the start-of-transition screen and processing for transcribing at least one item common to the start-of-transition screen and the end-of-transition screen into the data bean of the end-of-transition screen.

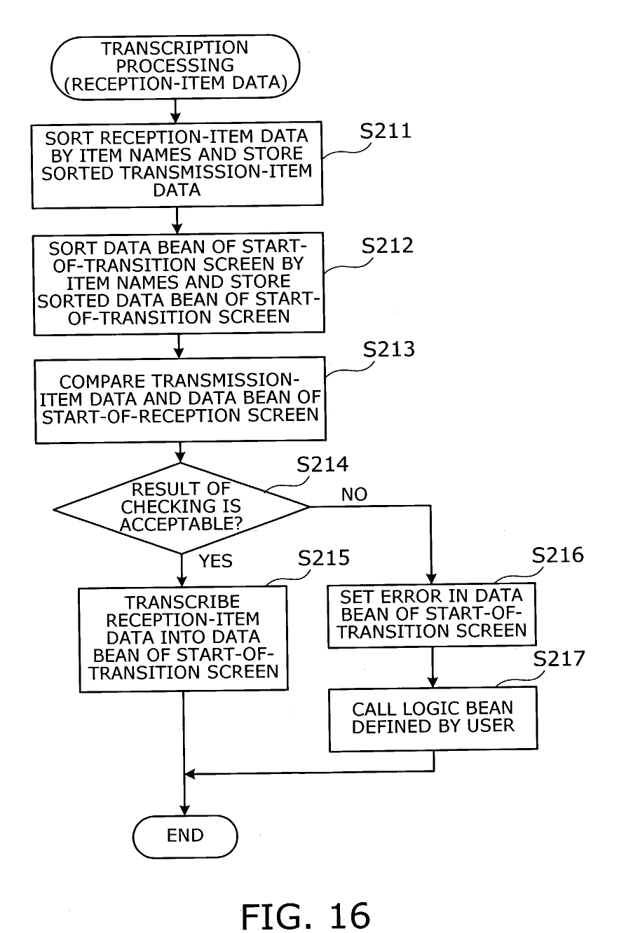

FIG. 16 is a flowchart of a sequence of the processing for transcribing reception-item data. This processing is performed when the reception-item data and the data bean of the start-of-transition screen are received from the screen-transition processing unit 171.

[Step S211] The transcription processing unit 172 sorts reception-item data by item names, and stores the sorted reception-item data in the RAM 102.

[Step S212] The transcription processing unit 172 sorts the data bean of the start-of-transition screen by item names, and stores the sorted data bean in the RAM 102.

[Step S213] The transcription processing unit 172 compares the reception-item data and the data bean of the start-of-transition screen. That is, each item in the reception-item data and an item in the data bean of the start-of-transition screen having the same item name are matched.

[Step S214] The transcription processing unit 172 checks whether or not data of each item in the reception-item data can be registered as data of an item in the data bean of the start-of-transition screen having the same item name as the item in the reception-item data. For example, when an item in the data bean of the start-of-transition screen has a numerical attribute, and the corresponding item in the reception-item data is a character string, an error occurs. When the result of the checking is acceptable, the operation goes to step S215. When the result of the checking is unacceptable, the operation goes to step S216.

[Step S215] The transcription processing unit 172 transcribes data of each item in the reception-item data into the data bean of the start-of-transition screen as data of an item in the data bean of the start-of-transition screen having the same item name (variable name) as the item in the reception-item data. Thereafter, the processing is completed.

[Step S216] The transcription processing unit 172 sets information indicating an occurrence of an error in the data bean of the start-of-transition screen.

[Step S217] The transcription processing unit 172 calls a logic bean defined by a user. That is, when a logic bean for the case of an error is specified by the user's definition, the logic bean performs the actual processing for the case of an error. Thereafter, the processing is completed.

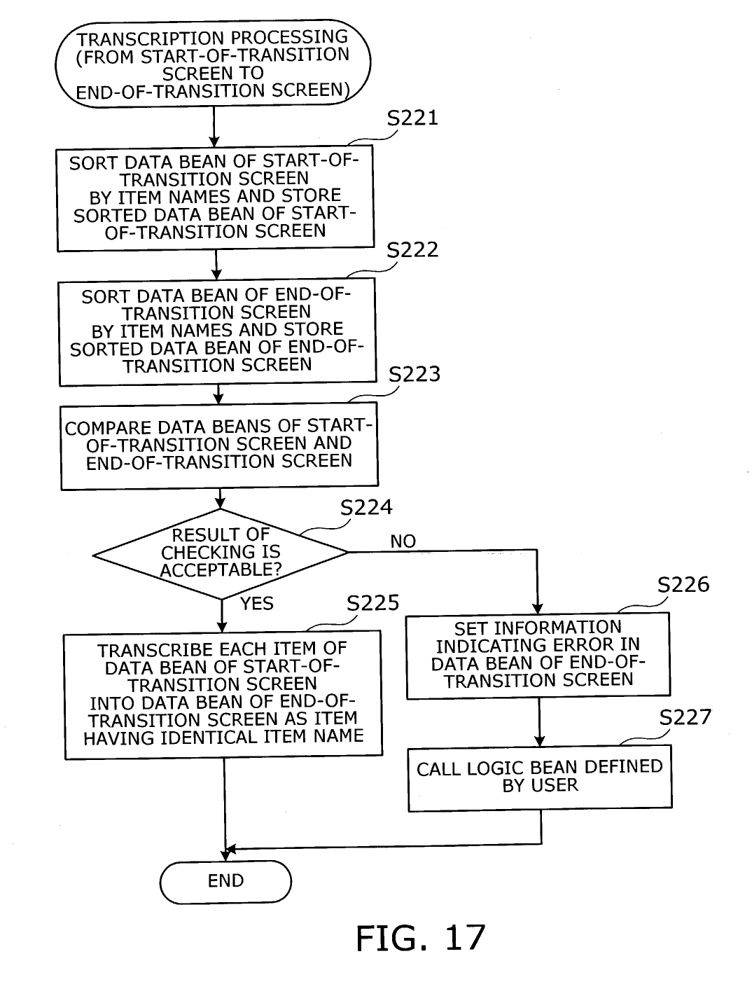

FIG. 17 is a flowchart of a sequence of processing for transcription from a start to an end of a transition. This processing is performed when the data beans of the start-of-transition screen and the end-of-transition screen are received from the screen-transition processing unit 171.

[Step S221] The transcription processing unit 172 sorts the data bean of the start-of-transition screen by item names, and stores the sorted data bean of the start-of-transition screen in the RAM 102.

[Step S222] The transcription processing unit 172 sorts the data bean of the end-of-transition screen by item names, and stores the sorted data bean of the end-of-transition screen in the RAM 102.

[Step S223] The transcription processing unit 172 compares the data bean of the start-of-transition screen and the data bean of the end-of-transition screen. That is, each item in the data bean of the start-of-transition screen and an item in the data bean of the end-of-transition screen having the same item name are matched.

[Step S224] The transcription processing unit 172 checks whether or not data of each item in the data bean of the start-of-transition screen can be registered as data of an item in the data bean of the end-of-transition screen having the same item name as the item in the data bean of the start-of-transition screen. When the result of the checking is acceptable, the operation goes to step S225. When the result of the checking is unacceptable, the operation goes to step S226.

[Step S225] The transcription processing unit 172 transcribes data of each item in the data bean of the start-of-transition screen into the data bean of the end-of-transition screen as data of an item in the data bean of the end-of-transition screen having the same item name (variable name) as the item in the data bean of the start-of-transition screen. Thereafter, the processing is completed.

[Step S226] The transcription processing unit 172 sets information indicating an occurrence of an error in the data bean of the end-of-transition screen.

[Step S227] The transcription processing unit 172 calls a logic bean defined by a user. That is, when a logic bean for the case of an error is specified by the user's definition, the logic bean performs the actual processing for the case of an error. Thereafter, the processing is completed.

Next, processing performed by the display processing unit 173 is explained.

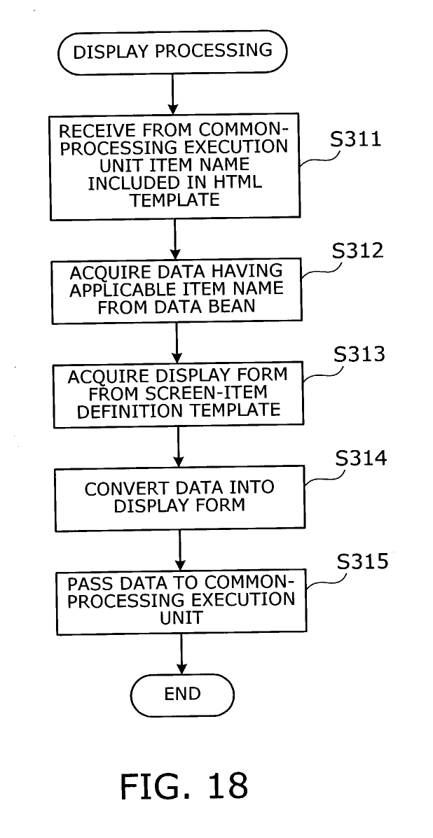

FIG. 18 is a flowchart of a sequence of display processing. The processing illustrated in FIG. 18 is explained below step by step.

[Step S311] The display processing unit 173 receives from the common-processing execution unit 160 at least one item name (or variable name) included in the HTML template of the end-of-transition screen.

[Step S312] The display processing unit 173 acquires data having an applicable item name in the data bean of the end-of-transition screen.

[Step S313] The display processing unit 173 accesses the screen-item definition template 110, and acquires a display form corresponding to the item name acquired in step S311.

[Step S314] The display processing unit 173 converts the data acquired in step S312, into the display form acquired in step S313.

[Step S315] The display processing unit 173 passes the converted data to the common-processing execution unit 160. Thus, the data registered in the data bean are converted into the display form, and displayed on the screen of the terminal 21.

Next, processing performed by the template management unit 190 is explained. The template management unit 190 performs processing for outputting an applicable record from the screen-item definition template 110 or the screen-transition-table template 120. In addition, the template management unit 190 performs other processing for adding to the screen-item definition template 110 or the screen-transition-table template 120 a record of differences from another screen-item definition template or another screen-transition-table template.

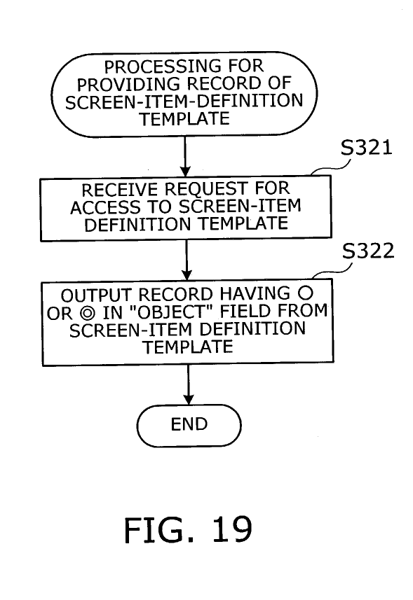

FIG. 19 is a flowchart of a sequence of processing for providing a record of the screen-item-definition template. This processing is performed when a request for access to the screen-item definition template 110 is received.

[Step S321] The template management unit 190 receives a request for access to the screen-item definition template 110.

[Step S322] The template management unit 190 outputs at least one record each having a flag indicated with a single circle or double circle in the field “Object” in the screen-item definition template 110. The outputted record can be displayed on the screen through a user interface or the like.

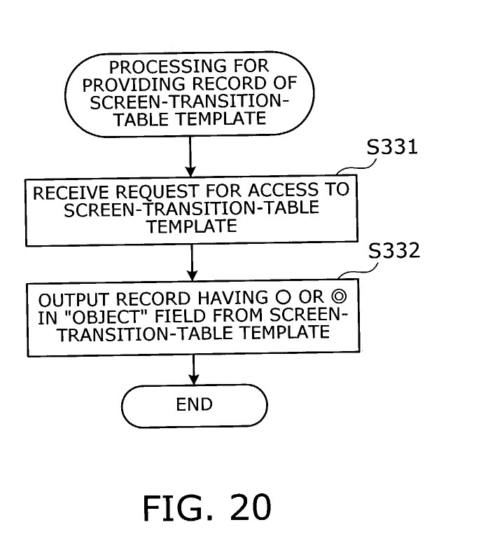

FIG. 20 is a flowchart of a sequence of processing for providing a record of the screen-transition-table template. This processing is performed when a request for access to the screen-transition-table template 120 is received.

[Step S331] The template management unit 190 receives a request for access to the screen-transition-table template 120.

[Step S332] The template management unit 190 outputs at least one record each having a flag indicated with a single circle or double circle in the field “Object” in the screen-transition-table template 120. The outputted record can be displayed on the screen through a user interface or the like.

As described above, the template management unit 190 provides only records each having a flag indicated with a single circle or double circle in the field “Object” in the screen-item definition template 110 and the screen-transition-table template 120. Therefore, records for which a blank is set in the field “Object” are treated as invalid records. That is, it is sufficient to merely set a blank in the field “Object” for items which are unnecessary to be applied.

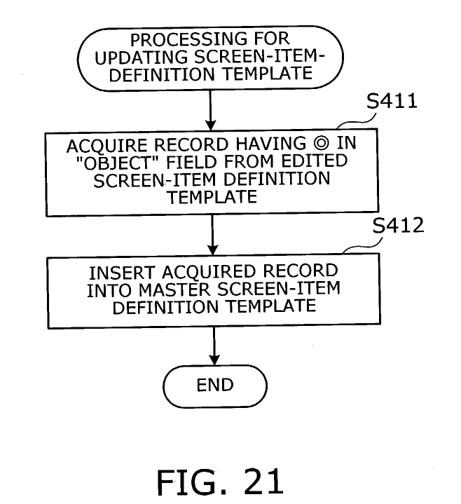

FIG. 21 is a flowchart of a sequence of processing for updating the screen-item-definition template. This processing is performed when a request for updating the screen-item definition template 110 (as a master) in accordance with a screen-item definition template for editing is received in a situation in which the screen-item definition template for editing is loaded in the RAM 102. The processing of FIG. 21 is explained below step by step.

[Step S411] The template management unit 190 acquires at least one record each having a flag indicated with a double circle in the field “Object” in the edited screen-item definition template.

[Step S412] The template management unit 190 inserts the acquired record into the screen-item definition template 110 as the master.

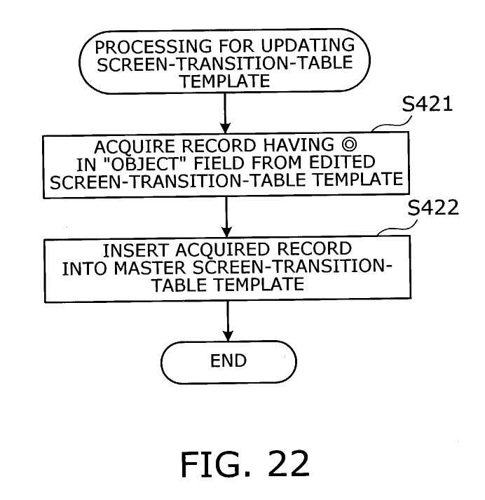

FIG. 22 is a flowchart of a sequence of processing for updating the screen-transition-table template. This processing is performed when a request for updating the screen-transition-table template 120 (as a master) in accordance with a screen-transition-table template for editing is received in a situation in which the screen-transition-table template for editing is loaded in the RAM 102. The processing of FIG. 22 is explained below step by step.

[Step S421] The template management unit 190 acquires at least one record each having a flag indicated with a double circle in the field “Object” in the screen-transition-table template.

[Step S422] The template management unit 190 inserts the acquired record into the screen-transition-table template 120 as the master.

As described above, only at least one record each having a flag indicated with a double circle in the field “Object” are added. Therefore, for example, when a portion of items in a screen-item definition template used in a company A is reused in a screen-item definition template in another company B, first, the screen-item definition template in the company A is opened (loaded in the RAM 102). Next, a double circle is set in the field “Object” for each of the items to be reused. Then, the screen-item definition template for the company B is determined to be a master, and a request for updating the screen-item definition template is output. Thus, it is possible to easily update the contents of the screen-item definition template in the company B.

An exemplary case where an arbitrary received-order entry screen is produced by using a template is explained below. In the following example, the item of the discount amount is removed from the received-order entry screen 201 illustrated in FIG. 13, and an item of a reception schedule is added. In order to change the received-order entry screen, the administrator of the web server 100 first produces an HTML template.

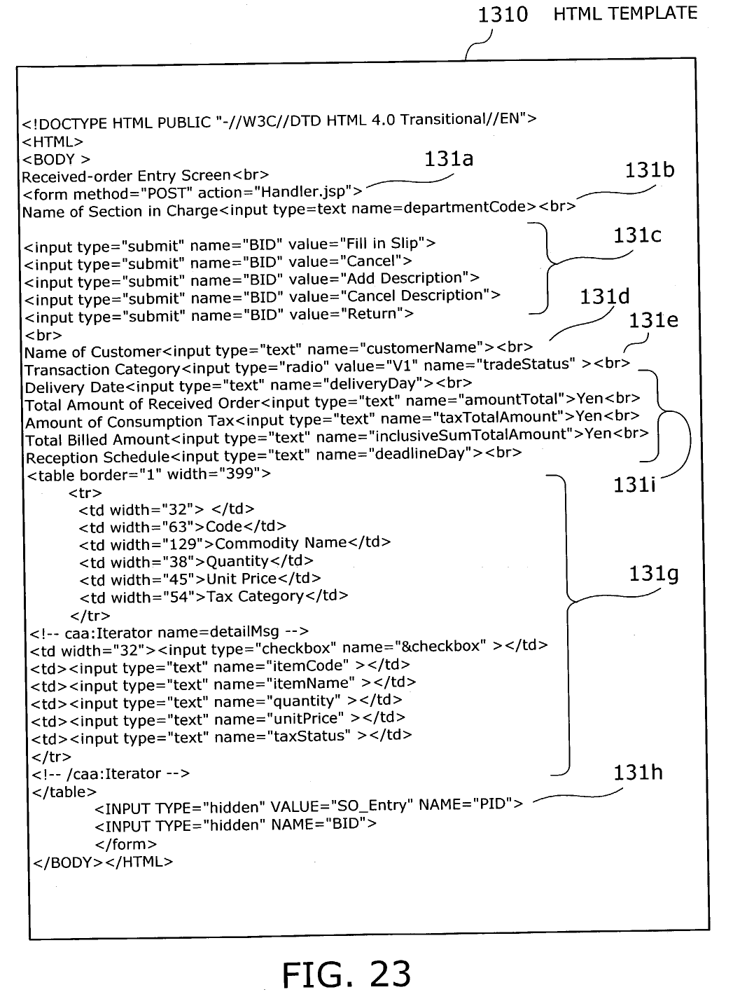

FIG. 23 is a diagram illustrating an example of an HTML template the contents of which are changed. The contents of the HTML template 1310 are identical to the contents of the HTML template 131 illustrated in FIG. 8 except that third input-item information 131i is included in the HTML template 131a. In FIG. 23, the same elements as the elements in the HTML template 131 illustrated in FIG. 8 bear the same reference numerals as FIG. 8, respectively, and therefore the explanations on the same elements are not repeated.

In the third input-item information 131i, the description corresponding to the discount amount (as illustrated in FIG. 8) is deleted from the third input-item information 131, and instead a description of a reception schedule is included. It is possible to easily produce the above HTML template 1310 by using the HTML template 131 illustrated in FIG. 8.

Next, the administrator of the web server 100 adds a record corresponding to the reception schedule to the screen-item definition template 110, and invalidates the record corresponding to the discount amount (i.e., makes the flag corresponding to the discount amount blank).

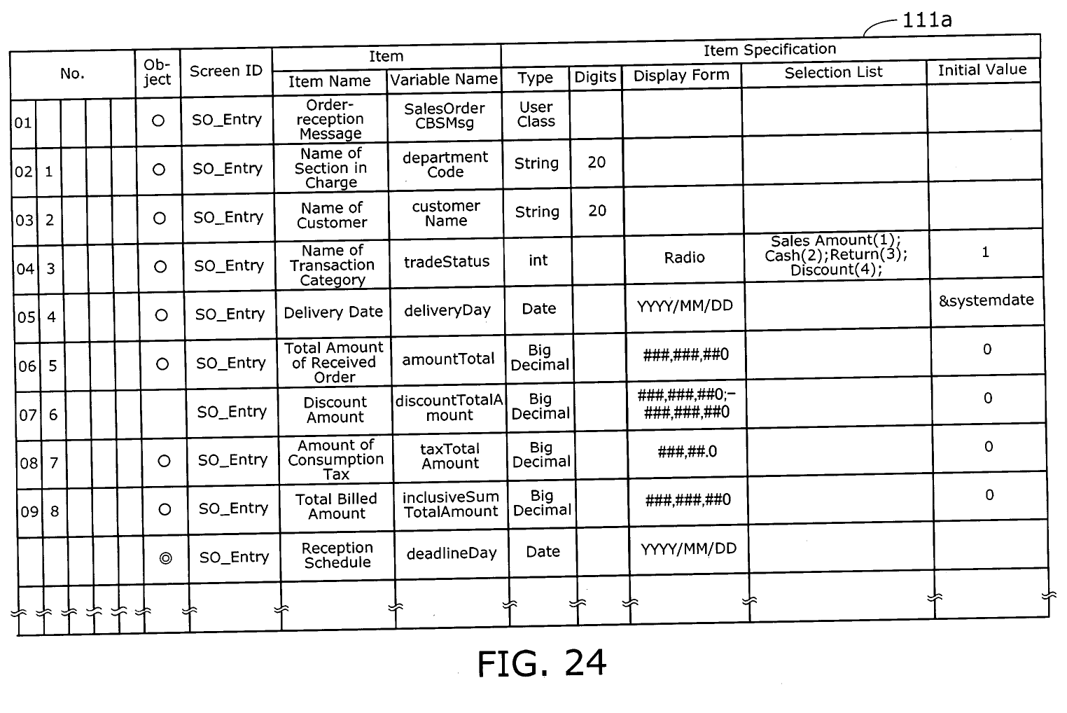

FIG. 24 is a diagram illustrating an example of the screen-item-definition template the contents of which are changed. In the screen-item definition template 111a after the change of the contents, the field “Object” in the record having the item name “Discount Amount” is made blank (while the field “Object” in the record having the item name “Discount Amount” indicates a single circle before the change). In addition, a record having an item name “Reception Schedule” is added, and a double circle is set in the field “Object” in the record.

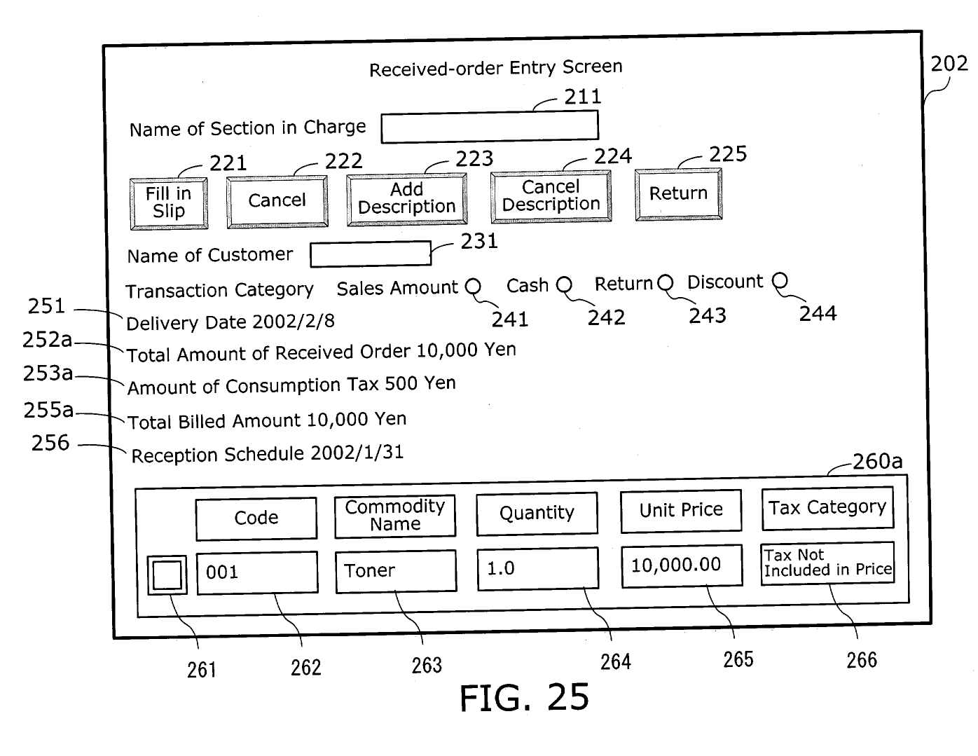

FIG. 25 is a diagram illustrating an example of the received-order entry screen after the contents of the received-order entry screen are changed. In the received-order entry screen 202 illustrated in FIG. 25, the same elements as the elements in the received-order entry screen 201 illustrated in FIG. 13 bear the same reference numerals as FIG. 13, respectively, and therefore the explanations on the same elements are not repeated.

The received-order entry screen 202 includes a receipt-schedule display unit 256, and does not include the discount-amount display unit 254a, which is displayed in the received-order entry screen 201 illustrated in FIG. 13.

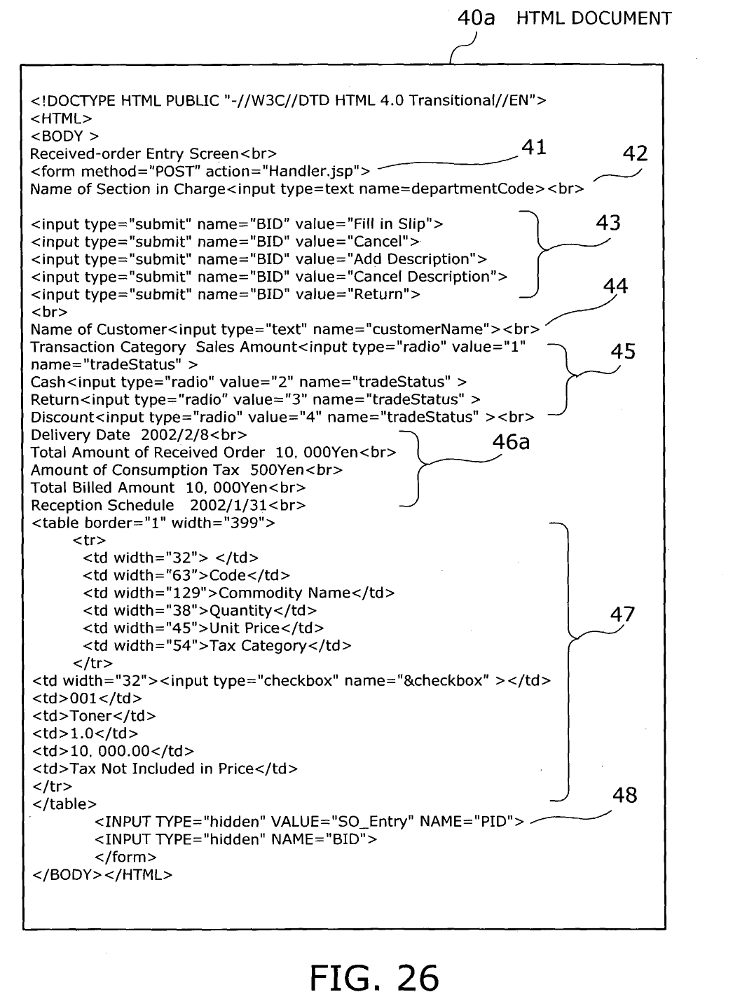

FIG. 26 is a diagram illustrating an example of the HTML document after the contents of the HTML document are changed. In the HTML document 40a illustrated in FIG. 26, the same elements as the elements in the HTML document 40 illustrated in FIG. 14 bear the same reference numerals as FIG. 14, respectively, and therefore the explanations on the same elements are not repeated. The HTML document 40a indicates that data registered as the delivery date, the total amount of the received order, the amount of the consumption tax, the total billed amount, and the reception schedule are displayed as third input-item information 46a. In the example of FIG. 26, the total amount of the received order “10,000 yen,” the amount of the consumption tax “500 yen,” the total billed amount “10,000 yen,” and the reception schedule “2002/1/31 are set as the data to be displayed.

As described above, it is possible to easily produce a web page for each company which starts e-commerce by starting up the web server 100. For example, when information inputted into a certain screen is transcribed into another screen by the conventional web server, it is necessary to produce a program for the transcription. Therefore, It is difficult for a person who does not have knowledge of programming (e.g., a sales person) to change the contents of a displayed screen. On the other hand, in the case of the web server 100 illustrated as the above embodiment, the user can change the contents of a displayed screen by merely changing the contents of an HTML template and editing a screen-item definition template. Therefore, the user can easily change the screen structure even when the user does not have knowledge of programming, where the change of the screen structure includes data transcription.

In particular, when the Java (trademark) technology such as JSP is used, it is possible to individually produce as a logic bean a processing program for each processing function. In the above embodiment, it is possible to easily link the above processing program for each processing function with an HTML template. Specifically, in the screen-transition-table template 120, a button in a start-of-transition screen can be linked with a logic bean. Thus, it is possible to easily produce a web page accompanied with server-side processing. For example, when a search engine is prepared as a logic bean, it is possible to easily produce a web page which utilizes the search engine.

In addition, the data structures of the screen-item definition template 110 and the screen-transition-table template 120 have a simple tabular form. Such data can be easily handled by using existing spreadsheet software (e.g., Excel, which is produced by Microsoft Corporation).

Further, since a flag indicating whether or not each record is to be processed is set in the record, it is easy to recognize which record corresponds to a difference. For example, by reference to this flag and use of spreadsheet software, it is possible to display or not to display only information used in each project. Furthermore, when only a record corresponding to a difference is extracted and merged into (i.e., additionally registered in) a master file, it is possible to easily produce the screen-item definition template 110 or the screen-transition-table template 120 as a logical sum of templates for the respective projects.

As explained above, the data structure of the screen-item definition template 110 or the screen-transition-table template 120 is simple. Therefore, even when the user does not have particularly advanced knowledge, it is possible to construct a web server in accordance with a new specification by reusing at least one program and data produced for the past projects.

The above processing functions can be realized by a server computer in a client-server system. In this case, a server program which describes details of processing for realizing the functions which a web server should have is provided. The server computer executes the server program in response to a request from a client computer. Thus, the above processing functions can be realized on the server computer, and processing results are supplied to the client computer.

The server program describing the details of the processing can be stored in a recording medium which can be read by the server computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the server program into the market, for example, it is possible to sell a portable recording medium such as a DVD or a CD-ROM in which the server program is recorded.

The server computer which executes the server program stores the server program in a storage device belonging to the server computer, where the server program is originally recorded in, for example, a portable recording medium. The server computer reads the server program from the storage device, and performs processing in accordance with the server program. Alternatively, the server computer may directly read the server program from the portable recording medium for performing processing in accordance with the server program.

As explained above, according to the present invention, when a button is pressed in a start-of-transition screen, an end-of-transition screen is determined in accordance with a screen-transition table, at least one item common to the start-of-transition screen and the end-of-transition screen is acquired based on item definition information, and data are transcribed from the start-of-transition screen into the end-of-transition screen. Therefore, in order to newly define a screen transition accompanied by data transcription, it is sufficient to set a new screen-transition relationship in the screen-transition table, and at least one item name of data to be transcribed into the end-of-transition screen in the item definition information. Therefore, it is easy to construct a new environment for provision of documents by reusing an existing screen-transition relationship.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A server program being executed by a computer for providing document data to a terminal, and making said computer perform a sequence of processing which comprises the steps of:
(a) determining an end-of-transition screen based on a screen-transition table in which a correspondence between the end-of-transition screen and a button being arranged in a start-of-transition screen and designating a screen transition is predefined, when said computer receives information indicating that an input by manipulation of said button in the start-of-transition screen occurs; and
(b) acquiring at least one name of at least one item which is set in both of said start-of-transition screen and said end-of-transition screen and is to be transcribed, based on first screen-item definition information in which names of items set in each of said start-of-transition screen and said end-of-transition screen are predefined, and transcribing data which is set as said at least one item in said start-of-transition screen, into said end-of-transition screen.

2. The server program according to claim 1, wherein a correspondence between said button in said start-of-transition screen and a description of processing which is to be executed when a screen transition is made is predefined, and
said computer performs the processing in accordance with said description corresponding to said button when said computer receives said information indicating that the input by manipulation of said button in the start-of-transition screen occurs.

3. The server program according to claim 1, wherein in data transcription into said end-of-transition screen, a document for display is produced by inserting said data set as said at least one item in said start-of-transition screen into a document template which is prepared in advance corresponding to said end-of-transition screen.

4. The server program according to claim 3, wherein in insertion of said data set as said at least one item in said start-of-transition screen into said document template, the data set as said at least one item in said start-of-transition screen is converted into data for display in accordance with a predefined display form, and the data for display is inserted into said document template.

5. The server program according to claim 1, wherein when second screen-item definition information is produced by editing details of said first screen-item definition information, information indicating a difference between said first and second screen-item definition information is registered in said second screen-item definition information.

6. The server program according to claim 5, wherein said information indicating the difference between said first and second screen-item definition information is a flag set for each item name.

7. A method executed by a server computer for providing document data to a terminal, comprising the steps of:
(a) determining an end-of-transition screen based on a screen-transition table in which a correspondence between the end-of-transition screen and a button being arranged in a start-of-transition screen and designating a screen transition is predefined, when said server computer receives information indicating that an input by manipulation of said button in the start-of-transition screen occurs; and
(b) acquiring at least one name of at least one item which is set in both of said start-of-transition screen and said end-of-transition screen and is to be transcribed, based on screen-item definition information in which names of items set in each of said start-of-transition screen and said end-of-transition screen are predefined, and transcribing data which is set as said at least one item in said start-of-transition screen, into said end-of-transition screen.

8. A server computer for providing document data to a terminal, comprising:
end-of-transition-screen determination means which determines an end-of-transition screen based on a screen-transition table in which a correspondence between the end-of-transition screen and a button being arranged in a start-of-transition screen and designating a screen transition is predefined, when said server computer receives information indicating that an input by manipulation of said button in the start-of-transition screen occurs; and
data transcription means which acquires at least one name of at least one item which is set in both of said start-of-transition screen and said end-of-transition screen and is to be transcribed, based on screen-item definition information in which names of items set in each of said start-of-transition screen and said end-of-transition screen are predefined, and transcribes data set as said at least one item in said start-of-transition screen, into said end-of-transition screen.

9. A computer-readable recording medium which stores a server program for providing document data to a terminal, said server program makes a computer perform a sequence of processing which comprises the steps of:
(a) determining an end-of-transition screen based on a screen-transition table in which a correspondence between the end-of-transition screen and a button being arranged in a start-of-transition screen and designating a screen transition is predefined, when said computer receives information indicating that an input by manipulation of said button in the start-of-transition screen occurs; and
(b) acquiring at least one name of at least one item which is set in both of said start-of-transition screen and said end-of-transition screen and is to be transcribed, based on screen-item definition information in which names of items set in each of said start-of-transition screen and said end-of-transition screen are predefined, and transcribing data which is set as said at least one item in said start-of-transition screen, into said end-of-transition screen.
